(19) United States
(12) Patent Application Publication
(10) Pub. No.: US 2008/0225097 A1
(43) Pub. Date: Sep. 18, 2008

(54) COLOR FILTER INK, COLOR FILTER, IMAGE DISPLAY, AND ELECTRONIC APPARATUS

(75) Inventors: Hiroshi TAKIGUCHI, Suwa-Shi (JP); Masaya SHIBATANI, Matsumoto City (JP); Hiroshi KIGUCHI, Suwa-Shi (JP)

Correspondence Address: HARNESS, DICKEY & PIERCE, P.L.C., P.O. BOX 828, BLOOMFIELD HILLS, MI, 48303, US

(73) Assignee: Seiko Epson Corporation, Tokyo (JP)

(21) Appl. No.: 12/046,813

(22) Filed: Mar. 12, 2008

(30) Foreign Application Priority Data
Mar. 13, 2007 (JP) 2007-064238

(51) Int. Cl. G02B 5/23; G01D 11/00

(52) U.S. Cl. 347/100; 252/586

(57) ABSTRACT

A color filter ink used for color filter production using an inkjet method includes a colorant and a liquid medium for dissolving and/or dispersing the colorant therein. When a product containing a cured epoxy adhesive is left undisturbed and sealed in the liquid medium for 6 days at an environmental temperature of 70° C. and under atmospheric pressure, the epoxy adhesive has a swelling ratio of 35% or less. Further, when a product containing a cured urethane adhesive is left undisturbed and sealed in the liquid medium for 6 days at an environmental temperature of 70° C. and under atmospheric pressure, the urethane adhesive has a swelling ratio of 160% or less.

### BACKGROUND

1. Technical Field

The present invention relates to color filter ink, a color filter, an image display, and an electronic apparatus.

2. Related Art

In general, liquid crystal displays (LCDs) use color filters for color-image display.

Conventional color filters are produced by the so-called photolithography technique. In this technique, a coating film is formed on a substrate. The coating film is made of a material (a colored-layer forming composite) including a colorant, a photosensitive resin, a functional monomer, and a polymerization initiator. Thereafter, UV light is irradiated thereon through a photomask to perform exposure, development, and the like. In this case, usually, the coating film, which corresponds to each color, is formed over approximately the entire surface of the substrate. Then, only a part of the film is hardened and a large part of the remainder of the film is removed. Those steps are repeated in such a manner that the colors do not overlap each other, so as to produce a color filter. Thus, although the coating film is formed to produce a color filter, the resulting final color filter contains only the part of the film left as each colored layer, whereas most of the originating film is removed in the production process. Consequently, the production cost is increased and such a production process is disfavored from resource conservation point of view.

Meanwhile, in recent years, there have been proposed methods for forming colored layers for a color filter by using an inkjet head (a liquid droplet discharging head) (e.g., see JP-A-2002-372613). Those methods enable easy control of conditions such as the discharging position of a liquid droplet made of each colored layer material (the colored-layer forming composite). Thus, material waste can be reduced, thereby lowering environmental stress and reducing the production cost. However, in the methods using the inkjet head, for example, the discharging amount of liquid droplets tends to be destabilized during a long-term discharging operation. This causes coloring density irregularities among a plurality of colored portions, which are basically required to have a uniform coloring density. As a result, the irregularities of color and density or the like occur in each region of the color filter. Additionally, variations are caused in characteristics (particularly, color characteristics such as a contrast ratio and a gamut of reproducible colors) among many color filters, leading to the deterioration of product reliability. Furthermore, a liquid droplet discharging apparatus (for industry use) used to produce a color filter is totally different from that (for general use) applied to a printer. For example, in order to achieve mass production of color filters, it is necessary to discharge a large amount of liquid droplets for long hours. Moreover, as compared to ink for general-use discharging apparatus applied to printers, ink for the industrial-use discharging apparatus used for color filter production has generally a higher viscosity and a larger specific gravity. Thus, a load exerted on the liquid droplet discharging head becomes much greater than in the general-use printer. The industrial-use discharging head is used under the harsh conditions as described above. Accordingly, the conventional methods using the inkjet head lead to deterioration of the inkjet head, so that replacement, repair or the like is more frequently desired. The replacement, repair or the like of the inkjet head requires readjustments of ink-discharging conditions (such as voltage-waveform adjustments) to suppress characteristic variations among the large number of color filters produced. This troublesome task lowers the productivity of color filters.

### SUMMARY

An advantage of the present invention is to provide a color filter ink that is stably and favorably used to produce a color filter by an inkjet method, where the irregularities of color and density in each region of the color filter are suppressed and characteristic variations among individual color filters are reduced. Another advantage of the invention is to provide a color filter achieving the above advantageous effects, an image display, and an electronic apparatus, both of which include the color filter.

The above advantages can be obtained by the following aspects of the invention.

A color filter ink according to a first aspect of the invention is used for color filter production using an inkjet method and includes a colorant and a liquid medium for dissolving and/or dispersing the colorant therein. When a product containing a cured epoxy adhesive is left undisturbed and sealed in the liquid medium for 6 days at an environmental temperature of 70° C. and under atmospheric pressure, the epoxy adhesive has a swelling ratio of 35% or less. When a product containing a cured urethane adhesive is left undisturbed and sealed in the liquid medium for 6 days at an environmental temperature of 70° C. and under atmospheric pressure, the urethane adhesive has a swelling ratio of 160% or less.

In this manner, a color filter ink can be obtained that can be used for an inkjet method, in which the irregularities of color and density or the like are suppressed in each region of the filter and the ink can be stably and favorably used to produce color filters with reduced characteristic variations among individual products.

Preferably, the color filter ink of the first aspect is discharged from a liquid droplet discharging head that includes a nozzle plate bonded with the epoxy adhesive and an oscillation plate bonded with the urethane adhesive, so as to be used for the color filter production.

In this manner, performance deterioration, clogging, or the like can be effectively prevented in the liquid droplet discharging head (the inkjet head) for discharging the color filter ink. Thus, a higher-quality color filter is produced and characteristic variations among individual color filters are excellently reduced.

Preferably, in the color filter ink of the first aspect, the epoxy adhesive includes an epoxy resin and an aliphatic polyamine.

The above composition enables a longer-term stable production of color filters in which the irregularities of color and density or the like in each region of the filters are more effectively suppressed and characteristic variations among individual color filters are more excellently reduced.

Preferably, in the color filter ink of the first aspect, the liquid medium has a boiling point in a range from 180 to 300° C. under atmospheric pressure.

In this manner, in the liquid droplet discharging head for discharging the color filter ink, problems such as clogging can be more effectively prevented, thereby further improving productivity.

Preferably, in the color filter ink of the first aspect, the liquid medium has a vapor pressure of 0.1 mmHg or less at 25° C.

In this manner, problems such as clogging are more effectively prevented in the discharging head for discharging the color filter ink. Thus, the productivity can be further improved.

Preferably, in the color filter ink of the first aspect, the liquid medium includes at least one compound selected from bis(2-butoxyethyl)ether, dipropylene glycol methyl ether acetate, methyl propylene triglycol, diethylene glycol monobutyl ether acetate, 1,3-butylene glycol diacetate, ethylene glycol diacetate, and 4-methyl-1,3-dioxolane-2-on.

This can effectively prevent the deterioration, clogging, or the like in the liquid droplet discharging head for discharging the color filter ink, whereby higher-quality color filters are produced and characteristic variations among individual color filters are more excellently reduced.

A color filter according to a second aspect of the invention is produced by using the color filter ink of the first aspect.

In this manner, a color filter can be produced in which irregularities of color and density or the like in each region of the filter are suppressed, and characteristic variations among individual color filters are excellently reduced.

An image display according to a third aspect of the invention includes the color filter of the second aspect.

In this manner, an image display can be produced in which irregularities of color and density or the like in each region of a display section are suppressed and characteristic variations among individual products are excellently reduced.

Preferably, the image display of the third aspect includes a liquid crystal display panel.

In this manner, an image display can be produced in which irregularities of color and density or the like in each region of the display section are suppressed and characteristic variations among individual products are excellently reduced.

An electronic apparatus according to a fourth aspect of the invention includes the image display of the third aspect.

In this manner, in the electronic apparatus of the fourth aspect, irregularities of color and density or the like in each region of the display section are suppressed, and characteristic variations among individual products are excellently reduced.

### BRIEF DESCRIPTION OF THE DRAWINGS

The invention will be described with reference to the accompanying drawings, wherein like numbers reference like elements.

FIG. 1 is a sectional view of a color filter according to a preferable embodiment of the invention.

FIGS. 2(1a)-2(1e) are sectional views showing a method for producing the color filter.

FIG. 3 is a perspective view of a liquid droplet discharging apparatus used to produce the color filter.

FIG. 4 is an illustration of a liquid droplet discharging unit as it appears when viewed from a stage side in the liquid droplet discharging apparatus shown in FIG. 3.

FIG. 5 is a bottom surface view of a liquid droplet discharging head included in the liquid droplet discharging apparatus of FIG. 3.

FIGS. 6A and 6B are a sectional perspective view and a sectional view, respectively, of the liquid droplet discharging head.

FIG. 7 is a sectional view of a liquid crystal display according to an embodiment of the invention.

FIG. 8 is a perspective view showing a structure of a mobile (or notebook) personal computer as an example of an electronic apparatus according to an embodiment of the invention.

FIG. 9 is a perspective view showing a structure of a mobile phone (such as a personal handy phone (PHS)) as another example of the electronic apparatus according to the embodiment.

FIG. 10 is a perspective view showing a structure of a digital still camera as another example of the electronic apparatus according to the embodiment.

### DESCRIPTION OF EXEMPLARY EMBODIMENTS

Hereinafter, exemplary embodiments of the invention will be described in detail.

Color Filter Ink

A color filter ink according to an embodiment of the invention is used to produce a color filter (more specifically, to form a colored portion of the color filter). In particular, the color filter ink of the embodiment is used for color filter production by using an inkjet method.

The color filter ink includes a colorant, a liquid medium for dissolving and/or dispersing the colorant therein, and a resinous material.

Colorants

A color filter usually has colored portions with a plurality of different colors, namely, colored portions with generally three colors corresponding to red (R), green (G), and blue (B). The colorant is usually selected in accordance with a tone of the color of each colored portion to be formed. As such colorants used for the color filter ink, there may be mentioned various pigments and dyes, for example.

Example of the pigments include C.I. Pigments Red 2, 3, 5, 17, 22, 23, 38, 81, 48:1, 48:2, 48:3, 48:4, 49:1, 52:1, 53:1, 57:1, 63:1, 112, 122, 144, 146, 149, 166, 170, 176, 177, 178, 179, 185, 202, 207, 209, 254, 101, 102, 105, 106, 108, and 108:1; C.I. Pigments Green 7, 36, 15, 17, 18, 19, 26, and 50; C.I. Pigments Blue 1, 15, 15:1, 15:2, 15:3, 15:4, 15:6, 17:1, 18, 60, 27, 28, 29, 35, 36, and 80; C.I. Pigments Yellow 1, 3, 12, 13, 14, 17, 55, 73, 74, 81, 83, 93, 94, 95, 97, 108, 109, 110, 129, 138, 139, 150, 151, 153, 154, 168, 184, 185, 34, 35, 35:1, 37, 37:1, 42, 43, 53, and 157; C.I. Pigments Violet 1, 3, 19, 23, 50, 14, and 16; C.I. Pigments Orange 5, 13, 16, 36, 43, 20, 20:1, and 104; and C.I. Pigments Brown 25, 7, 11, and 33.

As the dyes, there may be mentioned azo dyes, anthraquinone dyes, condensed polycyclic aromatic carbonyl dyes, indigoid dyes, carbonium dyes, phthalocyanine dyes, methine dyes, and polymethine dyes, for example. Particular examples of such dyes include C.I. Direct Reds 2, 4, 9, 23, 26, 28, 31, 39, 62, 63, 72, 75, 76, 79, 80, 81, 83, 84, 89, 92, 95, 111, 173, 184, 207, 211, 212, 214, 218, 221, 223, 224, 225, 226, 227, 232, 233, 240, 241, 242, 243, and 247; C.I. Acid Reds 35, 42, 51, 52, 57, 62, 80, 82, 111, 114, 118, 119, 127, 128, 131, 143, 145, 151, 154, 157, 158, 211, 249, 254, 257, 261, 263, 266, 289, 299, 301, 305, 319, 336, 337, 361, 396, and 397; C.I. Reactive Reds 3, 13, 17, 19, 21, 22, 23, 24, 29, 35, 37, 40, 41, 43, 45, 49, and 55; C.I. Basic Reds 12, 13, 14, 15, 18, 22, 23, 24, 25, 27, 29, 35, 36, 38, 39, 45, and 46; C.I. Direct Violets 7, 9, 47, 48, 51, 66, 90, 93, 94, 95, 98, 100, and 101; C.I. Acid Violets 5, 9, 11, 34, 43, 47, 48, 51, 75, 90, 103, and 126; C.I. Reactive Violets 1, 3, 4, 5, 6, 7, 8, 9, 16, 17, 22, 23, 24, 26, 27, 33, and 34; C.I. Basic Violets 1, 2, 3, 7, 10, 15, 16, 20, 21, 25, 27, 28, 35, 37, 39, 40, and 48; C.I. Direct Yellows 8, 9, 11, 12, 27, 28, 29, 33, 35, 39, 41, 44, 50, 53, 58, 59, 68, 87, 93, 95, 96, 98, 100, 106, 108, 109, 110, 130, 142, 144, 161, and 163; C.I. Acid Yellows 17, 19, 23, 25, 39, 40, 42, 44, 49, 50, 61, 64, 76, 79, 110, 127, 135, 143, 151, 159, 169, 174, 190, 195, 196, 197, 199, 218, 219, 222, and 227; C.I. Reactive Yellows 2, 3, 13, 14, 15, 17, 18, 23, 24, 25, 26, 27, 29, 35, 37, 41, and 42; C.I. Basic Yellows 1, 2, 4, 11, 13, 14, 15, 19, 21, 23, 24, 25, 28, 29, 32, 36, 39, and 40; C.I. Acid Green 16; C.I. Acid Blues 9, 45, 80, 83, 90, and 185; C.I. Basic Oranges 21 and 23.

Additionally, another colorant example may be a colorant prepared by performing a lyophilic treatment (a treatment for improving an affinity for a liquid medium as described below) on surfaces of powder particles made of any of the materials above. Thereby, for example, colorant particles included in the color filter ink can exhibit particularly excellent dispersibility and dispersion stability. As an example of the surface treatment of the colorant particles, there may be mentioned a treatment for changing the surface properties of the colorant particles by using a polymer. The polymer used to change the surface properties thereof may be, for example, a polymer described in JP-A-1996-259876 or the like, or any of polymers and oligomers used to disperse various commercially-available pigments.

Furthermore, the colorant may be made of a combination of two or more components selected from those mentioned above.

In the color filter ink, the colorant may be dissolved or dispersed in a liquid medium as described below. The colorant dispersed in the liquid medium preferably has a mean particle diameter in a range from 20 to 200 nm, and more preferably from 30 to 180 nm. In this manner, a color filter produced by using the color filter ink can exhibit a sufficiently excellent light resistance, as well as colorant dispersion stability in the color filter ink, coloring by the colorant in the color filter, and the like can be especially improved.

A content ratio of the colorant in the color filter ink ranges preferably from 2 to 20 wt %, and more preferably, from 3 to 15 wt %. The colorant having the content ratio within the above range can especially improve the discharging performance of a liquid droplet discharging head (an inkjet head) used for color filter production, and a color filter produced can have an excellent durability. Additionally, the produced color filter can ensure a sufficient coloring density.

Liquid Medium

A liquid medium (a liquid vehicle) has a function of dissolving and/or dispersing any of the colorants as mentioned above. In short, the liquid medium acts as a solvent and/or a dispersion medium. Usually, a large part of the liquid medium is removed in the production process of a color filter.

For example, the liquid medium may be ester compounds, ether compounds, hydroxyketones, carbon diesters, and cyclic amide compounds. Among them, preferable compounds belong to the following categories: (1) ethers (polyalcohol ethers) as condensation products of polyalcohols such as ethylene glycol, propylene glycol, butylene glycol, and glycerin, alkyl ethers of polyalcohol or polyalcohol ether, such as methyl ether, ethyl ether, butyl ether, and hexyl ether, and esters such as formate, acetate, and propionate; (2) esters of polycarboxylic acids (e.g. succinic acid and tartaric acid), such as methyl ester; (3) ethers, esters, and other compounds (hydroxy acids) each having at least one hydroxyl group and at least one carboxyl group in a molecular structure thereof; and (4) carbon diesters having a chemical structure as obtained by a reaction between polyalcohol and phosgene. Examples of the compounds usable as the liquid medium include 2-(2-methoxy-1-methylethoxy)-1-methylethylacetate, triethylene glycol dimethyl ether, ethylene glycol diacetate, diethylene glycol monoethyl ether acetate, 4-methyl-1,3-dioxolane-2-on, bis(2-butoxyethyl)ether, glutaric acid dimethyl, ethylene glycol di-n-butylate, 1,3-butylene glycol diacetate, diethylene glycol monobutyl ether acetate, tetraethylene glycol dimethyl ether, 1,6-diacetoxyhexane, methyl propylene triglycol, butoxy propanol, dipropylene glycol dimethyl ether, diethylene glycol dimethyl ether, ethyl 3-ethoxypropionate, diethylene glycol ethylmethyl ether, 3-methoxybutyl acetate, diethylene glycol diethyl ether, ethyl octanoate, ethylene glycol monobutyl ether acetate, cyclohexyl acetate, diethyl succinate, ethylene glycol diacetate, propylene glycol diacetate, 4-hydroxy-4-methyl-2-pentanone, dimethyl succinate, 1-butoxy-2-propanol, diethylene glycol monoethyl ether, diethylene glycol monomethyl ether, dipropylene glycol monomethyl ether, 3-methoxy-n-butyl acetate, dipropylene glycol n-propyl ether, polyethylene glycol monomethyl ether, butyl glycolate, ethylene glycol monohexyl ether, dipropylene glycol n-butyl ether, and N-methyl-2-pyrrolidone. Either one compound or a combination of two or more compounds selected from those above can be used as the liquid medium. Among them, preferable liquid media may include at least one compound selected from bis(2-butoxyethyl)ether, dipropylene glycol methyl ether acetate, methyl propylene triglycol, diethylene glycol monobutyl ether acetate, 1,3-butylene glycol diacetate, ethylene glycol diacetate, and 4-methyl-1,3-dioxolane-2-on. More preferable liquid media may include bis(2-butoxyethyl)ether, and much more preferable liquid media may mainly include bis(2-butoxyethyl)ether (in which, for example, a content ratio of bis(2-butoxyethyl)ether in the liquid medium is equal to or greater than 90 wt %). These compounds can effectively prevent deterioration, nozzle clogging or the like in the liquid droplet discharging head for discharging the color filter ink. Thus, high-quality color filters can be produced and characteristic variations among individual color filters can be excellently reduced.

The liquid medium included in the color filter ink according to the embodiment satisfies the conditions as described below.

First, when a cured product containing an epoxy adhesive is left undisturbed and sealed in the liquid medium for 6 days at an environmental temperature of 70° C. and under atmospheric pressure, the cured epoxy adhesive has a swelling ratio (hereinafter referred to as an “epoxy adhesive swelling ratio”) of 35% or less. In addition, when a cured product containing a urethane adhesive is left undisturbed and sealed in the liquid medium for 6 days at an environmental temperature of 70° C. and under atmospheric pressure, the cured urethane adhesive has a swelling ratio (hereinafter referred to as an “urethane adhesive swelling ratio”) of 160% or less. Satisfying these conditions can stabilize conditions such as the discharging amount of liquid droplets even when an extended discharging operation is performed to produce color filters by the inkjet method. Consequently, an extended production of color filters with a stable quality can be achieved. In other words, in each region of the produced filters, the irregularities of color and density or the like are suppressed, and thus color filters excellently reducing characteristic variations among individual products can be stably produced over a long period of time. Furthermore, satisfying the above conditions can effectively prevent the deterioration of the liquid droplet discharging head for discharging the color filter inks. Thus, even in the mass production of color filters, maintenance such as replacement or repair of the head does not have to be frequently performed, thereby excellently improving productivity of the color filter. In contrast, regarding the liquid medium, if at least one of the epoxy adhesive swelling ratio and the urethane adhesive swelling ratio is too large, discharging conditions of the inks are destabilized during a long-term discharging for color filter production using the inkjet method. Consequently, it is difficult to sufficiently prevent the irregularities of color and density or the like occurring in each region of the produced color filter. Furthermore, in the mass production of color filters, characteristic variations among individual products are increased, which hinders the stable production of high-quality color filters. Incidentally, the cured epoxy adhesive swelling ratio and the cured urethane adhesive swelling ratio can be measured by using disk-shaped specimens each having a diameter of 6 mm and a thickness of 4 mm, for example.

Preferably, the epoxy adhesive includes an epoxy resin and an aliphatic polyamine. When the epoxy adhesive is used to strongly fix a nozzle plate of the liquid droplet discharging head as described below to a head main body, the adhesive can effectively suppress undesired oscillation of the discharging head in the discharging operation of liquid droplets. However, conventional color filter inks are prone to affect the cured epoxy adhesive as described above. Thus, particularly the liquid droplet discharging head using the epoxy adhesive cannot maintain stable discharging conditions over a long period of time. Meanwhile, the liquid medium used in the embodiment does not affect the cured epoxy adhesive, and can more favorably stabilize discharging conditions such as the discharging amount of liquid droplets over a longer period of time. As a result, the irregularities of color and density or the like in each region of the color filter can be effectively suppressed. Therefore, the embodiment can more excellently reduce characteristic variations among individual color filters and enables stable production of the improved color filters over a longer period of time.

As described above, in the present embodiment, when the cured epoxy adhesive is left undisturbed in the sealed liquid medium for 6 days at the environmental temperature of 70° C. under atmospheric pressure, the adhesive has a swelling ratio of 35% or less. A preferable swelling ratio thereof left undisturbed in the liquid medium under the above conditions is 25% or less, and a more preferable swelling ratio thereof is 20% or less. In this manner, the advantageous effects of the embodiment can be obtained more remarkably.

Additionally, as described above, in the embodiment, the cured urethane adhesive left undisturbed in the sealed liquid medium for 6 days at the environmental temperature of 70° C. under atmospheric pressure has a swelling ratio of 160% or less. A preferable swelling ratio thereof left undisturbed in the liquid medium under the above conditions is 120% or less, and a more preferable swelling ratio thereof is 100% or less. In this manner, the above advantageous effects of the embodiment can be obtained more remarkably.

A boiling point of the liquid medium under atmospheric pressure (1 atmosphere) ranges preferably from 180 to 300° C., more preferably from 190 to 290° C., and much more preferably from 230 to 280° C. The liquid medium having the boiling point in the above range under atmospheric pressure can more effectively prevent clogging or the like in the liquid droplet discharging head for discharging the color filter ink, thereby further improving the productivity of the color filter.

A vapor pressure of the liquid medium at 25° C. is preferably 0.1 mmHg or less, and is more preferably 0.05 mmHg or less. When the liquid medium has a vapor pressure level in the above range, clogging or the like in the liquid droplet discharging head can be more effectively prevented, thereby further improving the productivity of the color filter.

A content ratio of the liquid medium in the color filter ink ranges preferably from 70 to 98 wt %, and more preferably from 80 to 95 wt %. When the content ratio thereof is in the above range, the liquid droplet discharging head used for the color filter production can exhibit a more excellent discharging performance, as well as a color filter produced can have an improved durability. Additionally, the produced color filter can obtain a sufficient coloring density.

Dispersants

The color filter ink may include a dispersant. In this manner, for example, even when the color filter ink includes a pigment having a low dispersibility, dispersion stability of the pigment can be made excellent, thereby improving the storing stability of the color filter ink.

As the dispersants, for example, there may be mentioned surfactants such as cation series, anion series, nonion series, amphoteric series, silicone series, and fluorine series. Particular examples of the surfactants include polyoxyethylene alkyl ethers such as polyoxyethylene lauryl ether, polyoxyethylene stearyl ether, and polyoxyethylene oleyl ether; polyoxyethylene alkyl phenyl ethers such as polyoxyethylene n-octylphenyl ether and polyoxyethylene n-nonylphenyl ether; polyethylene glycol diesthers such as polyethylene glycol dilaurate and polyethylene glycol distearate; sorbitan fatty acid esters; fatty acid denatured polyesters; tertiary amine-modified polyurethanes; and polyethylene imines. Additionally, there may be mentioned trade names such as KP (manufactured by Shin-Etsu Chemical Co., Ltd.), POLYFLOW (manufactured by Kyoeisya Chemical Co., Ltd.), FTOP (manufactured by Tohkem Products Co., Ltd.), MEGAFAC (manufactured by Dainippon Ink and Chemicals, Inc.), Fluorard (manufactured by Sumitomo 3M Ltd.), Asahi Guard and Surflon (manufactured by Asahi Glass Co., Ltd.), Disperbyk (manufactured by BYK-Chemie Japan Co., Ltd.), and Solsperse: 3000, 5000, 11200, 12000, 13240, 13650, 13940, 16000, 17000, 18000, 20000, 21000, 22000, 24000SC, and 24000GR (manufactured by Japan Lubrizol Limited).

Furthermore, for example, the dispersant may be a compound having a cyamelide ring. Using such a compound as the dispersant can provide more excellent dispersibility to the pigment included in the color filter ink and also can further improve discharging stability of the color filter ink.

Still furthermore, examples of the dispersant include compounds partially having structures as the following Formulas 1 and 2. Using such a compound as the dispersant can further improve dispersibility of the colorant (the pigment) included in the color filter ink, as well as can further improve the discharging stability of the color filter ink.

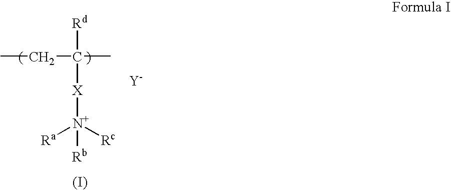

In the above formula, the symbols R^{a}, R^{b}, and R^{c} each independently may represent a hydrogen atom or a substitutable ring-shaped or chain-shaped hydrocarbon radical. Alternatively, two or more of the R^{a}, R^{b}, and R^{c} may be bonded together to form a ring structure. Symbol R^{d} represents a hydrogen atom or a methyl group. Symbol X represents a divalent linkage group and symbol Y⁻ represents a counter-anion.

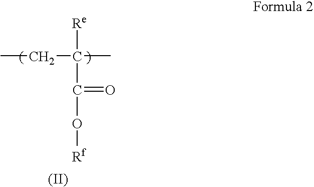

In the above formula, symbol R^{e} represents a hydrogen atom or a methyl group. Symbol R^{f} represents a ring-shaped or chain-shaped alkyl group that may have a substituent group, an aryl group that may have a substituent group, or an aralkyl group that may have a substituent group.

A content ratio of the dispersant in the color filter ink ranges preferably from 0.5 to 15 wt %, and more preferably from 0.5 to 8 wt %.

Resinous Materials

Color filter inks usually include a resinous material (a binder resin). Thus, regarding a color filter produced, a good adhesion can be obtained between a colored layer and a substrate, thereby improving the durability of the color filter.

The resinous material included in the color filter ink can be any kind of resin such as a thermoplastic or thermosetting resin, but preferable ones are epoxy resins that have a high transparency, a high hardness, and a small thermal contraction coefficient. Using any of the epoxy resins can further improve the adhesion of the colored portions to the substrate. Among them to be used as the resinous material included in the color filter ink, it is more preferable to use an epoxy resin having a molecular structure of silyl acetate (SiOCOCH₃) and an epoxy structure. Thereby, liquid droplets can be favorably discharged by using the inkjet method, and the adhesion between the colored layer and the substrate can be further improved. Consequently, the color filter produced can have a more excellent durability.

A content ratio of the resinous material in the color filter ink ranges preferably from 0.5 to 10 wt %, and more preferably from 1 to 5 wt %. The content ratio thereof in the above range can further improve dischargeability of ink from the liquid droplet discharging head used for color filter production, as well as can further improve the durability of the color filter produced. Additionally, the produced color filter can have a sufficient coloring density. Meanwhile, a too low content ratio thereof leads to a reduction of the dischargeability of the color filter ink or a lowering of the hardness of the colored portions to be formed, leading to a durability reduction of the color filter produced. Conversely, if the content ratio thereof is too high, it is difficult to ensure a sufficient coloring density in the color filter produced.

Other Components

The color filter ink may include various other components if desired. Examples of such components (other additives) include crosslinking agents; polymerization initiators; dispersion assistants such as blue pigment derivatives (e.g. copper phthalocyanine derivatives) and yellow pigment derivatives; fillers such as glass and alumina; high polymer compounds such as polyvinyl alcohol, polyethylene glycol monoalkyl ether, and polyfluoro alkyl acrylate; adhesion promoters such as vinyltrimethoxysilane, vinyltriethoxysilane, vinyl-tris(2-methoxyethoxy)silane, N-(2-aminoethyl)-3-aminopropyl methyl dimethoxysilane, N-(2-aminoethyl)-3-aminopropyl trimethoxysilane, 3-aminopropyl triethoxysilane, 3-glycidoxypropyl trimethoxysilane, 3-glycidoxypropyl methyl dimethoxysilane, 2-(3,4-epoxycyclohexyl)ethyltrimethoxysilane, 3-chloropropyl methyl dimethoxysilane, 3-chloropropyl trimethoxysilane, 3-methacryloxy propyl trimethoxysilane, and 3-mercaptopropyl trimethoxysilane; antioxidants such as 2,2-thiobis(4-methyl-6-t-butylphenol) and 2,6-di-t-butylphenol; ultraviolet light absorbers such as 2-(3-t-butyl-5-methyl-2-hydroxyphenyl)-5-chlorobenzotriazole and alkoxybenzophenon; cohesion inhibitors such as polyacrylic sodium; inkjet discharging performance stabilizers such as methanol, ethanol, i-propanol, n-butanol, and glycerin; and surfactants with the following brand names such as FTOP: EF301, EF303, and EF 352 (manufactured by Shin-Akita Chemical Co., Ltd.); Megafac: F171, F172, F173, and F178K (manufactured by Dainipponink and Chemicals Inc.); Fluorard FC430 and FC431 (manufactured by Sumitomo 3M Ltd.); Asahi Guard AG710, Surflon S-382, SC-101, SC-102, SC-103, SC-104, SC-105, and SC-106 (Asahi Glass Co., Ltd.); KP341 (Shin-Etsu Chemical Co., Ltd.); and PolyFlow No. 75 and No. 95 (manufactured by Kyoeisha Chemical Co., Ltd.).

Additionally, the color filter ink may include a thermal acid generator and an acid crosslinking agent. The thermal acid generator is a compound component that generates acid by heating, and preferable examples thereof include onium salts such as sulfonium salts, benzothiazolium salts, ammonium salts, and phosphonium salts. Particularly, sulfonium salts and benzothiazolium salts are more preferably used.

A viscosity of the color filter ink at 25° C. (a viscosity value measured by an oscillation viscometer) is not specifically restricted, but it ranges preferably from 5 to 15 mPa·S, and more preferably from 5 to 10 mPa·S. The viscosity of the color filter ink within the above range can significantly reduce variations among the discharging amounts of color filter ink droplets when the droplets are discharged by the inkjet method as described below. Additionally, the occurrence of clogging or the like in the discharging head can be more reliably prevented. The viscosity of the color filter ink can be measured by the oscillation viscometer or the like, and more particularly, can be measured in accordance with Japanese Industrial Standards (JIS) Z8809.

Ink Set

The above-described color filter ink is used for color filter production using the inkjet method. Usually, a color filter, which corresponds to a full-color image display, has the colored portions of a plurality of colors (usually, three colors of red (R), green (G), and blue (B) corresponding to the three primary colors of light). The colored portions of the three colors are formed by using a plurality of ink colors corresponding to the colored portions. In short, the color filter is produced by using an ink set including the color-filter inks of the multiple colors. In the embodiment, when producing the color filter, the color filter ink described above may be used to form at least one colored portion, but preferably is used to form the colored portions of all the colors.

Color Filter

Next, a description will be given of an example of the color filter produced by applying the color filter ink (the ink set) as described above.

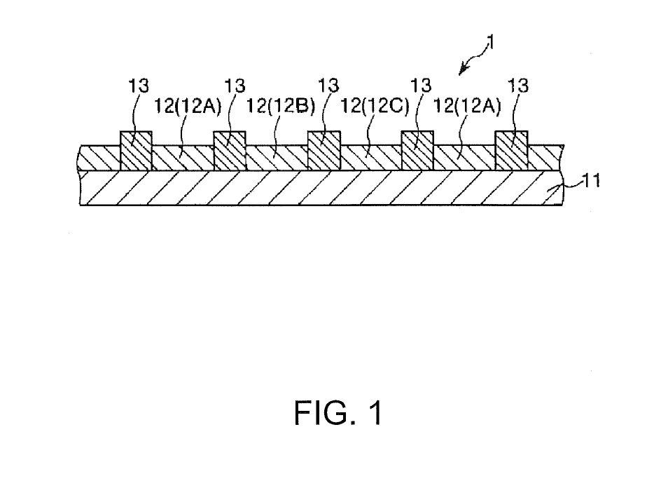

FIG. 1 is a sectional view of a color filter according to a preferable embodiment of the invention.

As shown in FIG. 1, a color filter 1 includes a substrate 11 and a colored portion 12 formed by using the color filter ink described above. The colored portion 12 includes a first colored portion 12A, a second colored portion 12B, and a third colored portion 12C, which are portions having mutually different colors. A partition wall 13 is disposed between respective adjacent ones of the colored portions 12A, 12B, and 12C.

Substrate

The substrate 11 is a plate-shaped member having optical transparency and retains the colored portions 12A to 12C and the partition walls 13 thereon.

Preferably, the substrate 11 is made of a substantially transparent material. Then, clearer images can be produced due to light transmitted through the color filter 1.

In addition, preferably, the substrate 11 has excellent heat resistance and mechanical strength. For example, this can reliably prevent deformation caused by heat applied in the production of the color filter 1. The material of the substrate 11 satisfying the above conditions may be glass, silicon, polycarbonate, polyester, aromatic polyamide, polyamideimide, polyimide, a norbornene-based ring-opening polymer, and a hydrogenerated product thereof, for example.

Colored Portion

Each colored portion 12 is formed by using the color filter ink described above.

Accordingly, characteristic variations among pixels can be reduced. Thus, the color filter 1 is highly reliable in that the irregularities of color and density or the like are suppressed.

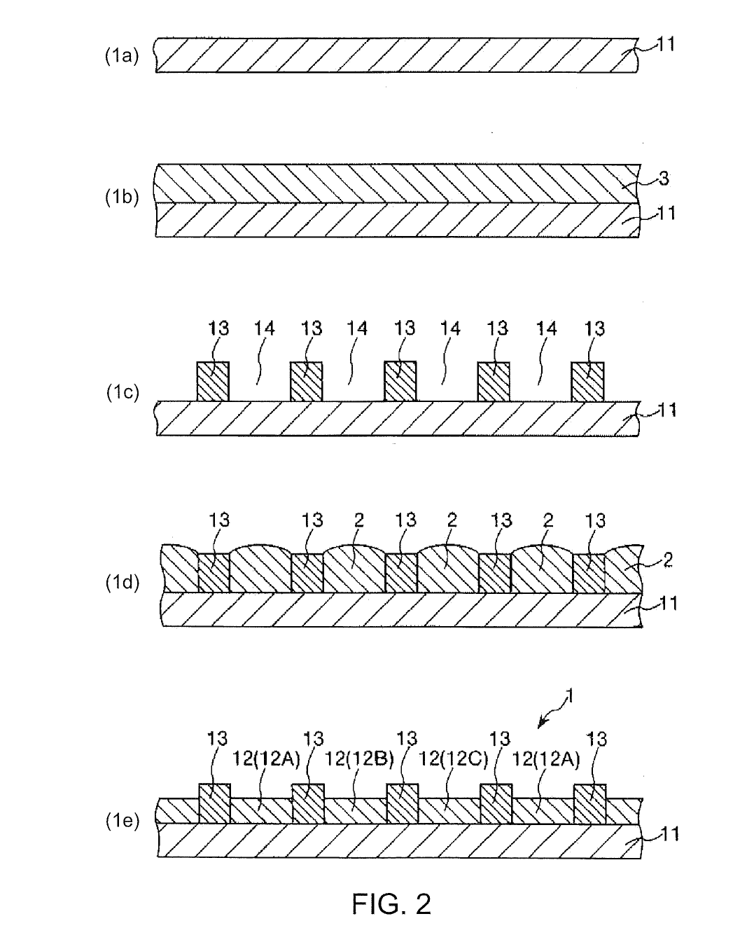

Each colored portion 12 is provided in a cell 14 (see FIG. 2), which is a region surrounded by the partition wall 13 described below.

The first colored portion 12A, the second colored portion 12B, and the third colored portion 12C have the mutually different colors. For example, the first colored portion 12A, the second colored portion 12B, and the third colored portion 12C, respectively, can be formed as a red filter region (R), a green filter region (G), and a blue filter region (B), respectively. A single pixel includes a set of the colored portions 12A, 12B, and 12C having the different colors. In the color filter 1, a predetermined number of the colored portions 12A to 12C are arranged horizontally and vertically. For example, when the color filter 1 is a high-vision color filter, it has 1366×768 pixels. Additionally, a full high-vision color filter has 1920×1080 pixels and a super high-vision color filter has 7680×4320 pixels. Furthermore, for example, the color filter 1 may have spare pixels outside the valid regions.

Partition Wall

The partition wall (bank) 13 is positioned between the respective adjacent ones of the colored portions 12A to 12C. This can reliably prevent color mixing between adjacent colored portions, so that clear images can be displayed.

The partition wall 13 may be made of a transparent material, but preferably it is made of a light-proof material, which can provide high-contrast image display. A color of the partition wall (a shielding portion) 13 is not specifically restricted, but preferably it is black. This can further improve the contrast of display images.

A height of the partition wall 13 is not specifically restricted, but preferably it is greater than a film thickness of the colored portion 12. Thereby, color mixing between the adjacent colored portions 12 can be reliably prevented. A particular thickness value of the partition wall 13 ranges preferably from 0.1 to 10 μm, and more preferably from 0.5 to 3.5 μm. Thereby, the color mixing therebetween can be reliably prevented, as well as an image display and an electronic apparatus each including the color filter 1 can obtain excellent viewing angle characteristics.

The partition wall 13 can be made of any material, but preferably it is mainly made of resin, for example. Thereby, the partition wall 13 can be easily formed into a desired shape by using a method as described below. Additionally, the partition wall 13 serving as the light shielding portion may include a light-absorbing material such as carbon black.

Color Filter Production Method

Next will be described an example of a method for producing the color filter 1.

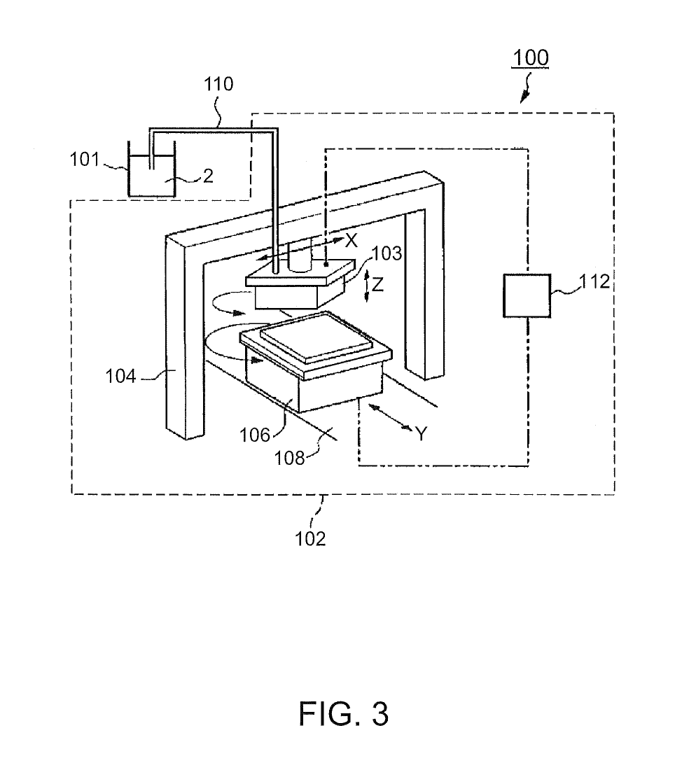

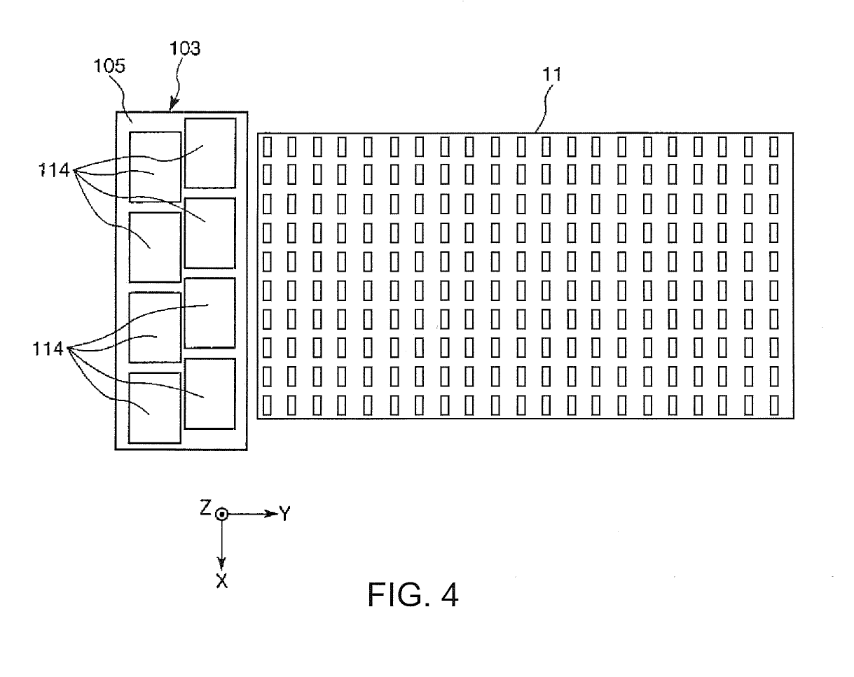

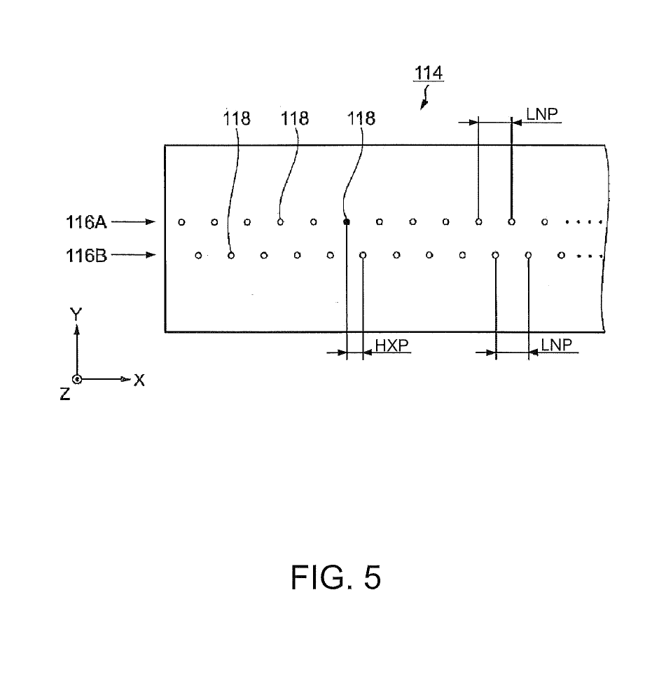

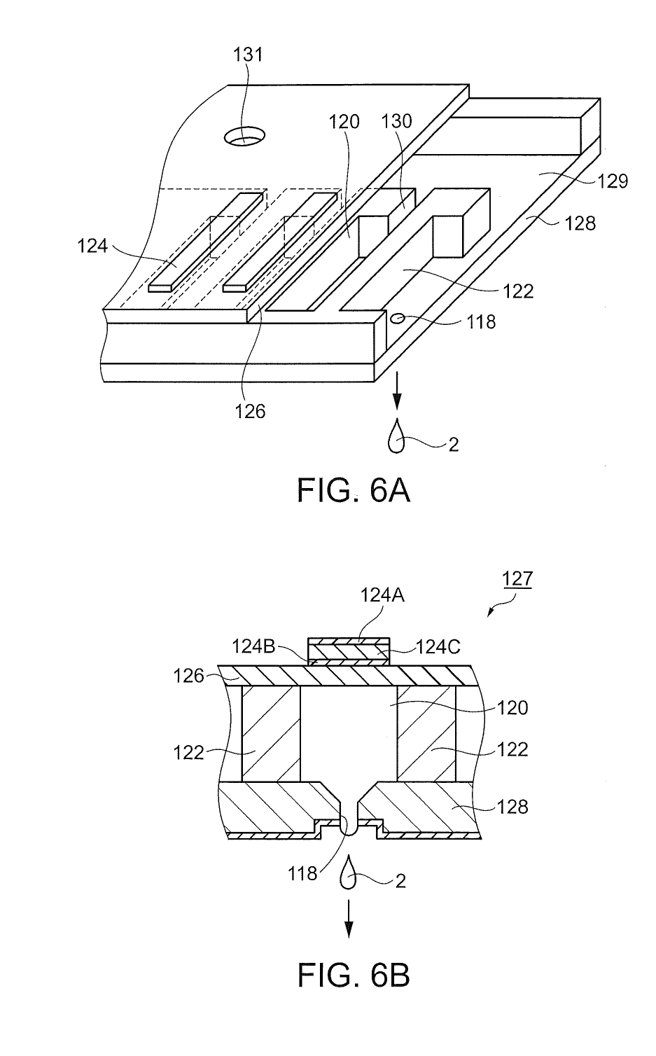

FIG. 2 is a sectional view showing the method for producing the color filter 1. FIG. 3 is a perspective view of a liquid droplet discharging apparatus used to produce the color filter 1. FIG. 4 is an illustration of a liquid droplet discharging unit as it appears when viewed from a stage side in the liquid droplet discharging apparatus shown in FIG. 3. FIG. 5 is a bottom surface view of a liquid droplet discharging head in the liquid droplet discharging apparatus shown in FIG. 3. FIGS. 6A and 6B are a sectional perspective view and a sectional view, respectively, of the liquid droplet discharging head.

As shown in FIG. 2, the color filter production method of the present embodiment includes a substrate preparation step for preparing the substrate 11 (1(a)), a partition-wall formation step for forming the partition wall 13 on the substrate 11(1(b) and 1(c)), an ink supply step for supplying a color filter ink 2 into each region surrounded by the partition wall 13 by using the inkjet method (1(d)), and a colored portion formation step for removing the liquid medium from the color filter ink 2 to form each solid colored portion 12 (1(e)).

Substrate Preparation Step

First, the substrate 11 is prepared (1(a)). The substrate 11 prepared in this step is preferably a substrate that has been subjected to a washing treatment. Additionally, the prepared substrate 11 may be a substrate subjected to an appropriate pretreatment such as a chemical treatment using a silane coupling agent or the like, a plasma treatment, ion plating, sputtering, a gas phase reaction process, or vacuum evaporation.

Partition Wall Formation Step

Next, a radiation-sensitive composite for forming the partition wall on the substrate 11 is supplied on approximately an entire area of a surface of the substrate 11 to form a coating film 3 (1(b)). In this case, if desired, prebaking treatment may be performed after supplying the radiation-sensitive composite on the substrate 11. For example, the prebaking treatment can be performed under conditions of a heating temperature of 50 to 150° C. and a heating time of 30 to 600 seconds.

Thereafter, through a photomask, radiation is irradiated to perform post-exposure baking treatment (PEB), followed by development treatment using an alkali developer, so as to form the partition wall 13 (1(c)). The PEB can be performed, for example, under conditions such as a heating temperature of 50 to 150° C., a heating time of 30 to 600 seconds, and a radiation irradiation intensity of 1 to 500 mJ/cm². Additionally, for example, the development treatment can be performed by liquid application, dipping, a vibration dipping method, or the like. The developing time can be set in a range of 10 to 300 seconds, for example. After the development treatment, post-baking treatment may be performed if desired. For example, the post-baking treatment can be performed under conditions such as a heating temperature in a range from 150 to 280° C. and a heating time in a range from 3 to 120 minutes.

Ink Supply Step

Next, the color filter ink 2 is supplied in each cell 14 surrounded by each partition wall 13 by the inkjet method (1(d)).

The present step is performed by using the plurality of kinds of color filter inks 2 corresponding to the colored portions 12 of the multiple colors to be formed. In this case, the formed partition wall 13 can reliably prevent mixing between at least two kinds of the color filter inks 2.

The color filter inks 2 are discharged by the liquid droplet discharging apparatus shown in FIGS. 3 to 6B.

As shown in FIG. 3, a liquid droplet discharging apparatus 100 used in this step includes a tank 101 for containing each of the color filter inks 2, a tube 110 and a discharging scan unit 102 for receiving the color filter ink 2 supplied from the tank 101 through the tube 110. The discharging scan unit 102 includes a liquid droplet discharging unit 103 having a plurality of liquid discharging heads (inkjet heads) 114 disposed on a carriage 105 (see FIG. 4), a first position controller 104 (a moving unit) for controlling a position of the liquid droplet discharging unit 103, a stage 106 for retaining the substrate 11 having the partition walls 13 formed thereon in the previous step (hereinafter simply referred to as “the substrate 11”), a second position controller 108 (a moving unit) for controlling a position of the stage 106, and a control unit 112. The tank 101 is connected to the liquid droplet discharging heads 114 (see FIG. 5) of the liquid droplet discharging unit 103 by the tube 110, through which the color filter ink 2 is supplied from the tank 101 to each of the liquid droplet discharging heads 114 by compressed air.

The first position controller 104 moves the liquid droplet discharging unit 103 in an X-axis direction and a Z-axis direction orthogonal to the X-axis direction in response to a signal from the control unit 112. Additionally, the first position controller 104 has a function of rotating the liquid droplet discharging unit 103 around an axis parallel to the Z axis. In the present embodiment, the Z-axis direction is equivalent to a direction parallel to a vertical direction (the direction of gravitational acceleration). The second position controller 108 moves the stage 106 in a Y-axis direction orthogonal to both the X-axis and the Y-axis directions in response to the signal from the control unit 112. Additionally, the second position controller 108 has a function of rotating the stage 106 around an axis parallel to the Z axis.

The stage 106 has a plane parallel to both the X-axis and the Y-axis directions. Additionally, the stage 106 is configured such that the substrate 11 having the cells 14 for supplying the color filter inks 2 therein can be fixed or retained on the plane.

As described above, the liquid droplet discharging unit 103 is moved in the X-axis direction by the first position controller 104, whereas the stage 106 is moved in the Y-axis direction by the second position controller 108. In short, the first and the second position controllers 104 and 108 change the relative position of the liquid droplet discharging head 114 with respect to the stage 106 (namely, the substrate 11 retained on the stage 106 and the liquid droplet discharging unit 103 move relative to each other).

The control unit 112 is configured so as to receive a discharge data signal transmitted from an external data processor. The discharge data indicates a relative position where the color filter ink 2 is to be discharged.

As shown in FIG. 4, the liquid droplet discharging unit 103 includes the liquid droplet discharging heads 114 each having approximately the same structure and the carriage 105 retaining the discharging heads. In the present embodiment, the discharging heads 114 of the liquid droplet discharging unit 103 includes eight heads. Each of the discharging heads 114 has a bottom surface with a plurality of nozzles 118 as described below. The bottom surface thereof has a polygonal shape having two long sides and two short sides and faces toward the stage 106. A long-side direction and a short-side direction of the discharging head 114, respectively, are parallel to the X-axis direction and the Y-axis direction, respectively.

As shown in FIG. 5, the liquid droplet discharging head 114 has the nozzles 118 arranged in the X-axis direction. The nozzles 118 are located such that a nozzle pitch HXP in the X-axis direction of the discharging head 114 has a predetermined value. A particular value of the nozzle pitch HXP is not specifically restricted. For example, the pitch may be set in a range of 50 to 90 μm. Additionally, “the nozzle pitch HXP in the X-axis direction of the discharging head 114” is equivalent to each pitch between nozzle images obtained by mapping all nozzles of the discharging head onto the X-axis in the Y-axis direction.

In the present embodiment, the nozzles 118 of the liquid droplet discharging head 114 forms a nozzle line 116A and a nozzle line 116B, both of which extend in the X-axis direction. The nozzle lines 116A and 116B are spaced apart from each other in parallel. In the present embodiment, each of the nozzle lines 116A and 116B includes the nozzles 118 including 90 nozzles arranged in a line in the X-axis direction with a predetermined pitch LNP therebetween. A particular value of the pitch LNP is not specifically restricted, but may be set in a range of 100 to 180 μm, for example.

A position of the nozzle line 116B is deviated with respect to a position of the nozzle line 116A by a half length of the nozzle pitch LNP in an X-axis positive direction (the right direction in FIG. 5). Thus, the nozzle pitch HXP in the X-axis direction of the discharging head 114 is equivalent to a half length of the nozzle pitch LNP of the nozzle line 116A (or the nozzle line 116B).

Accordingly, a nozzle linear density in the X-axis direction of the discharging head 114 is twice a nozzle linear density of the nozzle line 116A (or the nozzle line 116B). In the present specification, “the nozzle linear density in the X-axis direction” is equivalent to the number of a plurality of nozzle images per length obtained by mapping nozzle images on the X-axis in the Y-axis direction. It should be clear that the number of the nozzle lines included in the discharging head 114 is not restricted to only two. The discharging head 114 may have a number M of the nozzle lines, where M is a natural number equal to or greater than 1. In this case, in each of the number M of the nozzle lines, the nozzles 118 are arranged with a pitch that is M times longer than the nozzle pitch HXP. A case where the value of M is as a natural number equal to or greater than 2 is as follows: Relative to one of the number M of the nozzle lines, the number (M−1) of the remaining nozzle line(s) is/are deviated in the X-axis direction by a length that is “i” times the length of the nozzle pitch HXP, without mutually overlapping. A value of “i” is a natural number from 1 to (M−1).

In the present embodiment, each of the nozzle lines 116A and 116B includes the 90 nozzles 118. Thus, each of the liquid droplet discharging heads 114 has the nozzles 118 including 180 nozzles. In this case, respective five nozzles on opposite sides of the nozzle line 116A are designated as “resting nozzles”. Similarly, respective five nozzles on opposite sides of the nozzle queue 116B are designated as “resting nozzles”. The color filter inks 2 are not discharged from the resting nozzles (20 in total). Thus, 160 out of the 180 nozzles 118 of the liquid droplet discharging heads 114 act as those for discharging the color filter inks 2.

As shown in FIG. 4, in the liquid droplet discharging unit 103, the liquid droplet discharging heads 114 are arranged in two lines in the X-axis direction. The two lines of the discharging heads 114 are arranged such that one of the lines thereof partially overlaps the other line thereof when viewed from the Y-axis direction in consideration of the amount of the resting nozzles. Thereby, in the liquid droplet discharging unit 103, the nozzles 118 discharging the color filter inks 2 are continuously disposed with the above nozzle pitch HXP in the X-axis direction over a length as much as a size of the X-axis direction on the substrate 11.

In the liquid droplet discharging unit 103 of the present embodiment, the liquid droplet discharging heads 114 are arranged so as to cover an entire length equivalent to the size of the X-axis direction on the substrate 11. Alternatively, the discharging unit 103 of the embodiment may be configured such that the arrangement of the heads covers a part of the length equivalent thereto.

As shown in FIGS. 6A and 6B, each of the liquid droplet discharging heads 114 is an inkjet head. More specifically, the discharging head 114 includes an oscillation plate 126 and a nozzle plate 128. Between the oscillation plate 126 and the nozzle plate 128 is disposed a liquid reservoir 129, which is constantly filled with the color filter ink 2 supplied from the tank 101 through a hole 131.

Additionally, a plurality of partition walls 122 are disposed between the oscillation plate 126 and the nozzle plate 128. A cavity 120 is provided as a portion surrounded by the oscillation plate 126, the nozzle plate 128, and a pair of the partition walls 122. A cavity 120 corresponds to each of the nozzles 118, so that the number of cavities 120 is equal to the number of nozzles 118. The cavity 120 receives the color filter ink 2 supplied from the liquid reservoir 129 through a supply opening 130 positioned between a pair of the partition walls 122.

An oscillator 124 corresponding to each cavity 120 is disposed on the oscillation plate 126. The oscillator 124 includes a piezo element 124C and a pair of electrodes 124A and 124B sandwiching the piezo element therebetween. A drive voltage is applied between the electrodes 124A and 124B to discharge the color filter ink 2 from a corresponding one of the nozzles 118. Additionally, the shape of each nozzle 118 is adjusted such that the color filter ink 2 is discharged therefrom in the Z-axis direction.

In general, in such a liquid droplet discharging head, an adhesive is applied at portions where individual constituent members are bonded to each other. For example, adhesive is applied for bonding between the nozzle plate 128 and the partition walls 122, which has a great influence on the durability of the discharging head, and bonding between the oscillation plate 128 and the partition walls 122. When droplets of the color filter ink are repeatedly discharged and thus the color filter ink is continuously supplied to the discharging head (the cavity), oscillation energy or the like generated due to the droplet discharging operation is imparted to the portions bonded with the adhesive. Furthermore, liquid droplet discharging apparatuses (for industrial use) used for color filter production are completely different from those used for printers (for general use). For example, in order to produce a large number of color filters, the discharging apparatuses are required to discharge a massive amount of liquid droplets for long hours. Additionally, as compared to the ink used in discharging apparatuses applied as general-use printers, the ink used in the industrial-use discharging apparatuses for producing color filters has, generally, a high viscosity and a large specific gravity. Thus, the loads exerted on the discharging heads of the apparatuses are much greater than in the general-use printers. The industrial-use discharging apparatuses are operated under such harsh conditions. Consequently, in the conventional art, swelling of the adhesive can occur and the bonding provided by the adhesive can be insufficient due to the influence of the color filter ink, thereby leading to problems such as destabilization of the discharging amount of liquid droplets. Furthermore, for example, in the discharging apparatus used for color filter production, a cleaning task including suction is performed at regular intervals. In the suction step, if the bonding strengths of the nozzle plate and the oscillation plate are reduced, the plates may not resist the pressure change caused by the suction, thereby causing structural defects such as distortion or deflection. As a result, structural differences occur among some nozzles and thereby the discharging of the liquid droplets is destabilized, whereby the discharging amount of liquid droplets are different among the nozzles. This problem leads to coloring density irregularities among the colored portions, which are basically required to have a uniform coloring density. Thereby, the irregularities of color and density or the like occur in each region of a color filter, or variations in characteristics (particularly, color characteristics such as a contrast ratio and a gamut of reproducible colors) occur among multiple color filters, resulting in the deterioration of reliability in the color filters. In contrast, the color filter ink according to the present embodiment satisfies the conditions as described above. Thus, even in the extended discharging operation of liquid droplets, the color filter ink can effectively prevent the problems described above.

Although not specifically restricted, in the liquid droplet discharging head 114, preferably, the nozzle plate 128 is bonded with an epoxy adhesive having excellent chemical resistant properties, and also, preferably, the oscillation plate 126 is bonded with a urethane adhesive suitable to bonding between a resin film and a metal plate. Thereby, deterioration, clogging, or the like can be effectively prevented in the heads for discharging the color filter ink, and a higher-quality color filter can be produced and characteristic variations among individual products can be excellently reduced.

The epoxy adhesive used in the liquid droplet discharging head 114 preferably includes an epoxy resin and an aliphatic polyamine. When liquid droplets are discharged from the discharging head using the above epoxy adhesive therein, unfavorable oscillation of the discharging head can be effectively prevented. Meanwhile, conventional color filter inks are likely to affect a cured product of the above epoxy adhesive. Thus, when such a conventional color filter ink is used in the discharging head using the above epoxy adhesive therein, it is especially difficult to maintain stable discharging conditions over a long period of time. In contrast, the color filter ink of the present embodiment does not negatively affect the cured epoxy adhesive described above, so that discharging conditions such as the discharging amount of liquid droplets can be more appropriately stabilized. As a result, the irregularities of color and density or the like in each region of the filter can be more effectively suppressed. Accordingly, among the color filters produced as described above, characteristic variations can be reduced and also those color filters can be stably produced over a longer period of time.

The adhesive used in the liquid droplet discharging head 114 may be any of the following. Examples of the epoxy adhesive include AE-40 (manufactured by Ajinomoto-Fine-Techno Co., Inc.), 931-1 (manufactured by Ablestik Japan Co., Ltd.), Loctite 3609 (manufactured by Henkel Japan Co., Ltd.), and Scotch-Weld EW 2010 (manufactured by Sumitomo 3M Limited). Examples of the urethane adhesive include SU (manufactured by Konishi Bond Co., Ltd), Hysol U-09FL (manufactured by Henkel Corp.), and Takelac W (manufactured by Mitsui Chemicals, Inc.).

The control unit 112 (See FIG. 3) may be configured so as to send a signal independently to each oscillator 124. That is, in response to a signal from the control unit 112, a volume of the color film ink 2 discharged from each nozzle 118 may be controlled for each nozzle 118. Additionally, the control unit 112 may determine which of the nozzles 118 discharge liquid droplets or do not during scanning for ink application.

In the present specification, a portion including a single nozzle 118, the cavity 120 corresponding to the nozzle 118, and the oscillator 124 corresponding to the cavity 120 may be referred to as a “discharging portion 127”. In this case, a single liquid droplet discharging head 114 has the same number of the discharging portions 127 as the number of the nozzles 118.

The liquid droplet discharging apparatus 100 as described above is used to supply the color filter ink 2, which corresponds to each of the colored portions of the multiple colors in the color filter 1, into the cell 14. Using the discharging apparatus enables the color filter ink 2 to be efficiently and selectively supplied thereinto. In the structure shown in the drawing, the liquid droplet discharging apparatus 100 has the tank 101 for retaining the color filter ink, the tube 110 and the like that are used for only a single color. However, in order to correspond to the colored portions 12A to 12C of multiple colors in the color filter 1, the discharging apparatus 100 may include constituent members equal to the number of the colors. Additionally, in the production of the color filter 1, as the discharging apparatus 100, a plurality of liquid droplet discharging apparatuses may be used to correspond to the color filter inks 2 of the multiple colors.

In the present embodiment, the liquid droplet discharging head 114 may use an electrostatic actuator instead of the piezo element, as a drive element. Alternatively, the discharging head 114 may use an electro-thermal transducing element as the drive element, so as to take advantage of material thermal expansion caused by the transducing element to discharge the color filter ink.

Colored Portion Formation Step

Next, the liquid medium is removed from the color filter ink 2 inside the cell 14 to form each solid colored portion 12 (1(e)), whereby the color filter 1 is obtained. Additionally, in the present step, a resinous material may be reacted with a crosslinking component or the like if desired. The liquid medium can be removed by heating, for example. In this case, the substrate 11 with the color filter ink 2 applied thereon may be placed under a depressurized environment. As a result, damage to the substrate 11 or the like can be prevented, and the removal of the liquid medium can be more efficiently promoted. Furthermore, in the present step, radiation may be applied to efficiently promote the reaction between the resinous material and the crosslinking component or the like.

Image Display

Next, a description will be given of an image display (an electro-optical device) having the color filter 1 according to a preferable embodiment of the invention.

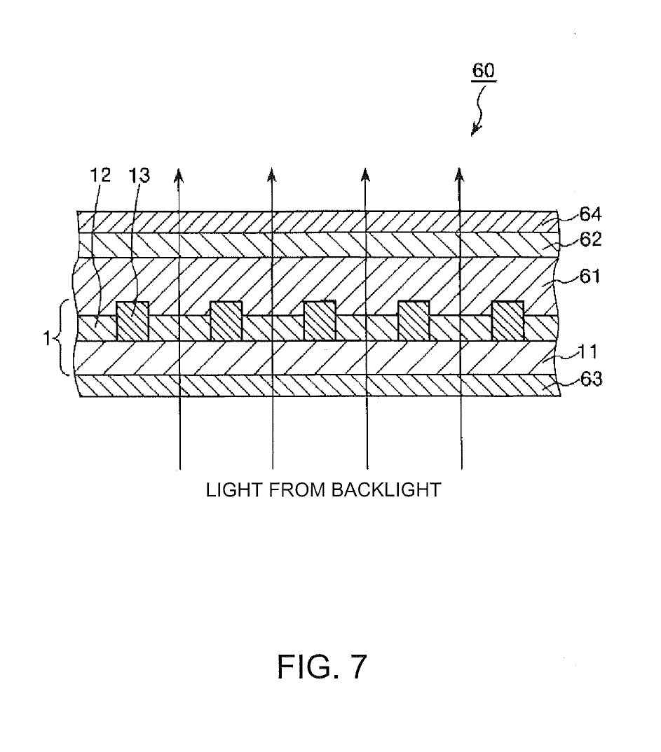

FIG. 7 is a sectional view of a liquid crystal display according to the preferable embodiment. As shown in FIG. 7, a liquid crystal display 60 includes the color filter 1, a substrate (an opposing substrate) 62 disposed to oppose the colored portions 12 of the color filter 1, a liquid crystal layer 61 made of liquid crystal enclosed in a space between the color filter 1 and the substrate 62, a polarizing plate 63 disposed under the substrate 11 of the color filter 1 in FIG. 7, and a polarizing plate 64 disposed on the substrate 62 in FIG. 7. The substrate 62, which has visible light transmittance, may be a glass substrate, for example.

The liquid crystal display 60 includes a plurality of pixel electrodes arranged in a matrix and having visible light transmittance, a plurality of switching elements (e.g. thin film transistors TFTs) corresponding to the pixel electrodes, and a common electrode having visible light transmittance. The transistors and the common electrode are not shown in the drawing.

In the liquid crystal display 60, light emitted from a backlight (not shown) is input from one side of the color filter 1 (a lower side in FIG. 7). Then, the light input to each of the colored portions 12A, 12B, and 12C of the color filter 1 is output as the light of a color corresponding to each colored portion from an opposite surface side of the filter.

As described above, the colored portions 12 are formed by using the color filter ink of the embodiment, thereby suppressing characteristic variations among the pixels. Consequently, the liquid crystal display 60 can stably present display images, in which the irregularities of color and density or the like in each region are suppressed.

Electronic Apparatus

An image display (the electro-optical device) 1000 such as the above liquid crystal display 60 having the color filter 1 can be used in a display section of various electronic apparatuses.

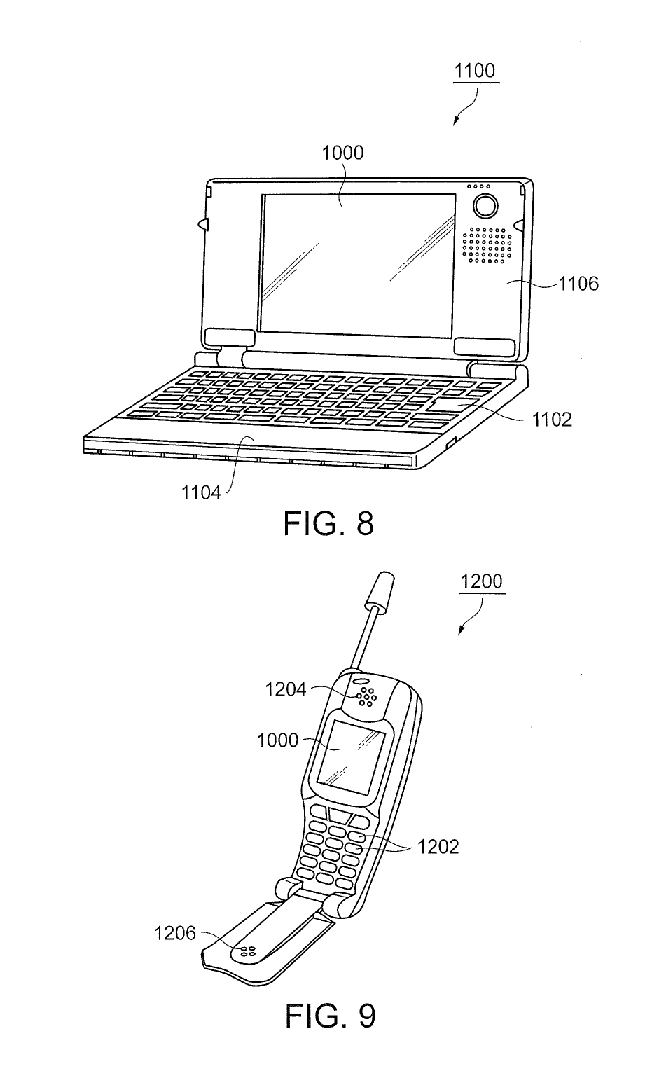

FIG. 8 is a perspective view showing a structure of a mobile (or a notebook) personal computer as an application example of an electronic apparatus according to an embodiment of the invention.

In the drawing, a personal computer 1100 includes a main body 1104 having a keyboard 1102 and a display unit 1106. The display unit 1106 is rotatably supported with respect to the main body 1104 by means of a hinged portion.

In the personal computer 1100, the display unit 1106 includes the image display 1000.

FIG. 9 is a perspective view showing a structure of a mobile phone (such as a PHS) as another application example of the electronic apparatus according to the embodiment.

In the drawing, a mobile phone 1200 includes a plurality of touch buttons 1202, a speaker aperture 1204, and a microphone aperture 1206, as well as it includes the image display 1000 in its display section.

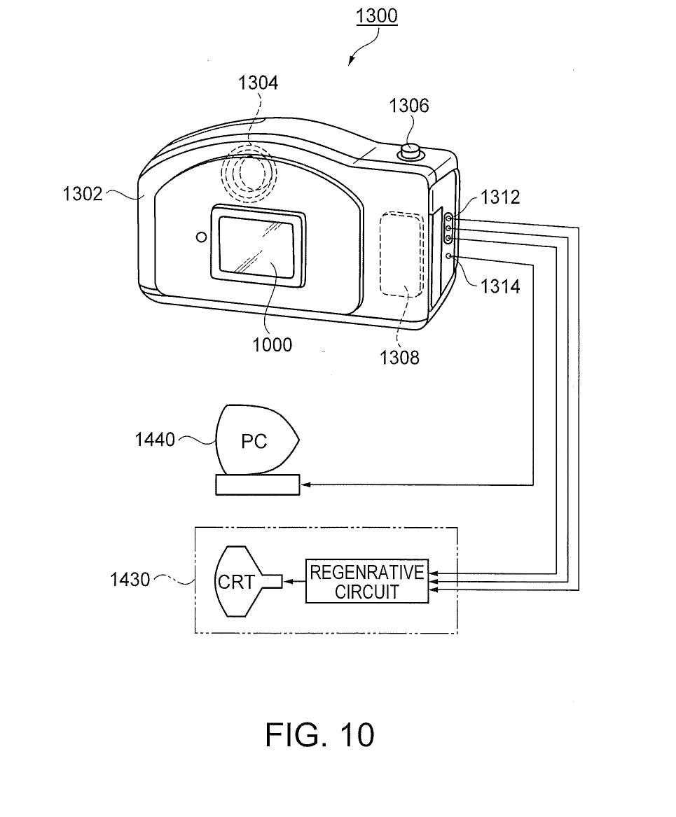

FIG. 10 is a perspective view showing a structure of a digital still camera as another application example of the electronic apparatus according to the embodiment. FIG. 10 also simply shows connections between the camera and external apparatuses.

In an ordinary camera, a silver halide film is exposed to light by an optical image of a subject. However, a digital still camera 1300 photoelectrically converts the optical image of the subject by using an image-pickup element such as a charge-coupled device (CCD) to generate an image-pickup signal (an image signal).

On a rear surface of a casing (body) 1302 of the digital still camera 1300, the image display 1000 is disposed in the display section to show images on a display screen based on image-pickup signals from the CCD, whereby the image display 1000 serves as a finder for displaying the subject as an electronic image.

The casing includes a circuit substrate 1308 therein. On the circuit substrate 1308 is provided a memory allowing storage (memorizing) of image-pickup signals.

On a front surface (a back surface of the structure shown in the drawing) of the casing 1302 is provided a light-receiving unit 1304 including an optical lens (an image-pickup optical system), CCD, and the like.

When a photographer confirms a subject image displayed on the display section and then pushes down a shutter button 1306, an image signal of the CCD at the point in time is transferred to and stored in the memory of the circuit substrate 1308.

In the digital still camera 1300, a video signal output terminal 1312 and an input-output terminal 1314 used for data communications are disposed on a side surface of the casing 1302. Then, as shown in the drawing, the video signal output terminal 1312 is connected to a television monitor 1430, and the input-output terminal 1314 for data communications is connected to a personal computer 1440, respectively, as desired. Furthermore, with a predetermined operation, the image-pickup signal stored in the memory of the circuit substrate 1308 is outputted to the television monitor 1430 or the personal computer 1440.

The electronic apparatus of the embodiment can be applied to various kinds of apparatuses other than to the (mobile) personal computer, the mobile phone, and the digital still camera described above. Examples of such apparatuses include a television set (e.g. liquid crystal television set), a video camera, a view-finder type or monitor direct-view-type video tape recorder, a laptop personal computer, a car navigation device, a pager, an electronic organizer (with communications functions), an electronic dictionary, an electronic calculator, an electronic game device, a word processor, a work station, a video phone, a security television monitor, an electronic binocular, a POS terminal, apparatuses equipped with touch panels (e.g. cash dispensers in banking facilities, automatic ticket vending machines), medical apparatuses (e.g. an electronic thermometer, an electronic manometer, a glucosemeter, an electrocardiographic equipment, an ultrasonic diagnostic equipment, an endoscopic display), a fish detector, measuring equipments, gauging instruments (e.g. instruments of vehicles, airplanes and ships), a flight simulator, other kinds of monitors, and a projection display apparatus such as a projector. Particularly, regarding television sets, recent TV display panels have become increasingly larger. In such an electronic apparatus having a large display section (e.g. a display section having a diagonal-line length of 80 cm or longer), color filters produced by using conventional color filter inks are more likely to cause the irregularities of color and density or the like. However, applying the embodiment of the invention ensures prevention of the occurrence of the problems. In other words, when the color filter of the embodiment is used in an electronic apparatus with a large display section as described above, the advantageous effects of the embodiment can be exhibited more remarkably.

Although the description has been given based on the preferable embodiments, the invention is not restricted to those embodiments.

For example, in the above embodiment, after supplying the color filter ink corresponding to the colored portion of each color into the cell, the liquid medium is removed collectively from the color filter inks of the colors in the cell. That is, in the description provided above, the colored portion formation step is performed only one time. However, the ink supply step and the colored portion formation step may be repeated for each color.

Additionally, in the color filter of the embodiment, a protective film for covering the colored portions may be disposed on a surface side opposite to a surface side of the colored portions facing the substrate. Thereby, damage, deterioration, and the like in the colored portions can be more effectively prevented.

Each portion included in the color filter, the image display, and the electronic apparatus can be replaced by an arbitrary portion having the same function, or another appropriate structure can be added.

### EXAMPLES

### 1. Preparation of Color Filter Ink

### Example 1

First, as the resinous material, a resin “a” was synthesized as described below.

After placing 320 pts. wt. of n-hexane, 86 pts. wt. of meta acrylic acid, and 111 pts. wt. of triethylamine in a four-neck flask, the flask was fitted with a thermometer, a reflux condenser, a stirrer, and a nitrogen gas outlet. The four-neck flask was cooled in iced water, while dropping 120 pts. wt. of trimethyl chlorsilane. In this situation, a temperature inside the reaction system was set to 25° C. or less. Thereafter, the reaction was continued for 1 hour at 25° C. Next, deposited hydrochloride of triethylamine was separated by filtration. The n-hexane was removed from the obtained filtrate under reduced pressure, and then, the residue was purified by reduced-pressure distillation to obtain an ethylenically unsaturated monomer having the molecular structure of silyl-acetate.

Next, there was prepared a four-neck flask fitted with a thermometer, a reflux condenser, a stirrer, and a nitrogen gas outlet, in which 100 pts. wt. of bis(2-butoxyethyl)ether as a solvent was placed. The bis(2-butoxyethyl)ether in the flask was heated up to 60° C. while being stirred. Thereafter, a mixture of 27 pts. wt. of the ethylenically unsaturated monomer, 30 pts. wt. of meta acrylic acid glycidyl, 38 pts. wt. of styrene, and 6 pts. wt. of 2,2′-azobis-(2,4-dimethylvaleronitrile) was dropped in the flask for 1 hour. After the dropping, the reaction mixture was kept at 60° C. for 1 hour, and then, 0.08 pts. wt. of 2,2′-azobis-(2,4-dimethylvaleronitrile) was added and the resulting mixture was reacted at 60° C. for 6 hours. Thereafter, unreacted monomers were removed by depressurization to obtain a solution of the resin “a” as an epoxy resin having the molecular structures of silyl acetate and epoxy.

Meanwhile, there was prepared bis(2-butoxyethyl)ether (a liquid medium), to which Disperbyk-161 (a compound having a cyamelide ring; manufactured by BYK-Chemie Japan Co., Ltd.) as a dispersant and C.I. Pigment Red 254 as a colorant were added. Then, the mixture was introduced into a bead mill using zirconia beads of 0.65 mm to grind the pigment, so as to obtain a pigment dispersion liquid.

Thereafter, the solution of the resin “a” and the pigment dispersion liquid were mixed to prepare a color filter ink of red color (R ink). A mean particle diameter of the C.I. Pigment Red 254 included in the R ink was 160 nm.

Additionally, color filter inks of green (G ink) and blue (B ink) were also prepared in the same manner as in the color filter ink of the red color except that instead of the C.I. Pigment Red 254, C.I. Pigment Green 36 and C.I. Pigment Blue 15:6, respectively, were used and the amount of the liquid medium was changed. As a result, an ink set including the three ink colors of R, G, and B was obtained. A mean particle diameter of the C.I. Pigment Green 36 in the G ink and a mean particle diameter of the C.I. Pigment Blue 15:6 in the B ink were both 160 nm.

### Examples 2 to 13

Furthermore, color filter inks (an ink set) were prepared in the same manner as in Example 1 except that the kind of liquid medium and the amount of each component were set as shown in a table. When changing the composition of the liquid medium, the resin “a” was synthesized by using a solvent having a composition changed in accordance with the changed composition of the liquid medium. Then, the solvent of the resin “a” synthesized in that manner was used to prepare each color filter ink.

### Comparative Examples 1 to 8

Still furthermore, color filter inks (an ink set) were prepared in the same manner as in Example 1 except that the kind of liquid medium and the amount thereof were set as shown in the table. When changing the composition of the liquid medium, the resin “a” was synthesized by using a solvent having a composition changed in accordance with the changed composition of the liquid medium. Then, the solvent of the resin “a” synthesized in that manner was used to prepare each color filter ink.

Regarding the Examples (Exs.) and the Comparative Examples (C. Exs.), the composition and the viscosity of each of the color filter inks, and the properties of the liquid medium, are all shown in Tables 1, 2, and 3. In those tables, C.I. Pigment Red 254 is represented as “PR 254”; C.I. Pigment Green 36 is represented as “PG 36”; C.I. Pigment Blue 15:6 is represented as “PB 15:6”; Pigment Yellow 150 is represented as “PY 150; the resin “a” is represented as “a”; Disperbyk-161 (the dispersant) is represented as “b”; bis(2-butoxyethyl)ether is represented as “A”; 2-(2-methoxy-1-methylethoxy)-1-methylethylacetate is represented as “B”; methyl propylene triglycol is represented as “C”; diethylene glycol monobutyl ether acetate is represented as “D”; 1,3-butylene glycol diacetate is represented as “E”; ethylene glycol diacetate is represented as “F”; 4-methyl-1,3-dioxolane-2-on is represented as “G”; diethylene glycol monoethyl ether acetate is represented as “H”; glutaric acid dimethyl is represented as “I”; tetraethylene glycol dimethyl ether is represented as “J”; and triethylene glycol dimethyl ether is represented as “K”. Additionally, in the tables, in the column of “viscosity”, there are shown viscosity values of the color filter inks at 25° C. measured by the oscillation viscometer in accordance with JIS-Z8809. In the column of “boiling point”, there are shown the values of boiling points at a normal atmospheric pressure (1 atmospheric pressure) of the liquid medium. In the column of “vapor pressure”, vapor pressure values of the liquid medium at 25° C. are shown. In the column of “swelling ratio of cured epoxy adhesive”, there are shown values indicating the swelling ratio of a cured product of an epoxy adhesive obtained when the cured product (a disk-shaped specimen having a diameter of 6 mm and a thickness of 4 mm) of the epoxy adhesive (AE-40 manufactured by Ajinomoto-Fine-Techno and including an epoxy resin and an aliphatic polyamine) is left undisturbed in the liquid medium sealed for 6 days at an environmental temperature of 70° C. under an atmospheric pressure. In the column of “swelling ratio of cured urethane adhesive”, there are shown values indicating the swelling ratio of a cured product of a urethane adhesive obtained when the cured product (a disk-shaped specimen having a diameter of 6 mm and a thickness of 4 mm) of the urethane adhesive (Hysol U-09FL manufactured by Henkel Corp.) is left undisturbed in the liquid medium sealed for 6 days at the environmental temperature of 70° C. under the atmospheric pressure.

TABLE 1

| | | Color Filter Ink | | | | | | | | | | | | | | |
|---|---|---|---|---|---|---|---|---|---|---|---|---|---|---|---|---|
| | | Composition | | | | | | | | | | | Properties of Liquid Medium | | | |
| | | | | | | Resin | | | | Liquid | | | | | Swelling | Swelling |
| | | Colorant | | | | Material | | Dispersant | | Medium | | Viscos- | Boil- | | Ratio (%) | Ratio (%) |
| | | | content | | content | | content | | content | | content | ity | ing | Vapor | of Cured | of Cured |
| | | | (pts. | | (pts. | | (pts. | | (pts. | | (pts. | (mP · | Point | Pressure | Epoxy | Urethane |
| | | | wt.) | | wt.) | | wt.) | | wt.) | | wt.) | S) | (° C.) | (mmHg) | Adhesive | Adhesive |
| Ex 1 | R | PR254 | 5.3 | PY150 | 2.0 | a | 1.9 | b | 4.8 | A | 86.0 | 6.2 | 256.0 | 0.01 | 7.89 | 13.96 |
| | G | PG36 | 7.2 | PY150 | 2.9 | a | 2.0 | b | 4.8 | A | 83.1 | 6.0 | 256.0 | 0.01 | 7.89 | 13.96 |
| | B | PB15:6 | 4.9 | — | — | a | 1.9 | b | 4.5 | A | 88.7 | 5.8 | 256.0 | 0.01 | 7.89 | 13.96 |
| Ex 2 | R | PR254 | 5.0 | PY150 | 2.0 | a | 2.2 | b | 4.8 | A/B | 43.0/43.0 | 5.1 | 234.5 | 0.01 | 14.80 | 37.70 |
| | G | PG36 | 7.2 | PY150 | 2.9 | a | 2.2 | b | 4.9 | A/B | 41.4/41.4 | 5.0 | 234.5 | 0.01 | 14.80 | 37.70 |
| | B | PB15:6 | 5.0 | — | — | a | 1.9 | b | 4.5 | A/B | 44.3/44.3 | 5.0 | 234.5 | 0.01 | 14.80 | 37.70 |
| Ex 3 | R | PR254 | 5.1 | PY150 | 1.9 | a | 2.0 | b | 4.8 | A/D | 43.1/43.1 | 7.2 | 251.4 | 0.02 | 19.76 | 40.56 |
| | G | PG36 | 7.0 | PY150 | 2.8 | a | 2.0 | b | 4.8 | A/D | 41.7/41.7 | 7.1 | 251.4 | 0.02 | 19.76 | 40.56 |
| | B | PB15:6 | 4.7 | — | — | a | 1.8 | b | 4.5 | A/D | 44.5/44.5 | 7.0 | 251.4 | 0.02 | 19.76 | 40.56 |
| Ex 4 | R | PR254 | 5.2 | PY150 | 2.1 | a | 2.1 | b | 4.8 | A/E | 42.9/42.9 | 6.9 | 244.0 | 0.02 | 20.08 | 63.59 |
| | G | PG36 | 7.4 | PY150 | 2.9 | a | 2.2 | b | 4.7 | A/E | 41.4/41.4 | 7.0 | 244.0 | 0.02 | 20.08 | 63.59 |
| | B | PB15:6 | 4.9 | — | — | a | 1.9 | b | 4.6 | A/E | 44.3/44.3 | 6.9 | 244.0 | 0.02 | 20.08 | 63.59 |
| Ex 5 | R | PR254 | 5.3 | PY150 | 2.2 | a | 1.9 | b | 4.6 | A/I | 68.6/17.2 | 6.5 | 247.0 | 0.03 | 17.25 | 55.67 |
| | G | PG36 | 7.5 | PY150 | 2.9 | a | 2.1 | b | 4.9 | A/I | 66.1/16.5 | 6.6 | 247.0 | 0.03 | 17.25 | 55.67 |
| | B | PB15:6 | 4.8 | — | — | a | 2.1 | b | 5.1 | A/I | 70.6/17.6 | 6.4 | 247.0 | 0.03 | 17.25 | 55.67 |
| Ex 6 | R | PR254 | 5.1 | PY150 | 1.9 | a | 2.9 | b | 5.4 | B | 84.7 | 4.7 | 213.0 | 0.02 | 21.66 | 61.43 |
| | G | PG36 | 7.3 | PY150 | 2.0 | a | 2.8 | b | 5.0 | B | 82.9 | 4.9 | 213.0 | 0.02 | 21.66 | 61.43 |
| | B | PB15:6 | 4.9 | — | — | a | 1.8 | b | 4.9 | B | 88.4 | 4.6 | 213.0 | 0.02 | 21.66 | 61.43 |
| Ex 7 | R | PR254 | 5.2 | PY150 | 1.9 | a | 2.9 | b | 4.8 | B/C | 51.1/34.1 | 8.2 | 224.6 | 0.02 | 23.92 | 60.36 |
| | G | PG36 | 7.3 | PY150 | 2.0 | a | 1.9 | b | 5.1 | B/C | 50.2/33.5 | 7.9 | 224.6 | 0.02 | 23.92 | 60.36 |
| | B | PB15:6 | 4.9 | — | — | a | 2.4 | b | 5.8 | B/C | 52.1/34.8 | 8.0 | 224.6 | 0.02 | 23.92 | 60.36 |
| Ex 8 | R | PR254 | 5.3 | PY150 | 2.0 | a | 2.7 | b | 5.0 | B/D | 42.5/42.5 | 7.5 | 256.0 | 0.01 | 7.89 | 13.96 |
| | G | PG36 | 7.2 | PY150 | 3.1 | a | 1.6 | b | 5.1 | B/D | 41.5/41.5 | 7.3 | 256.0 | 0.01 | 7.89 | 13.96 |
| | B | PB15:6 | 4.7 | — | — | a | 1.9 | b | 5.0 | B/D | 44.2/44.2 | 7.1 | 256.0 | 0.01 | 7.89 | 13.96 |

TABLE 2

| | | Color Filter Ink | | | | | | | | | | | | | | |
|---|---|---|---|---|---|---|---|---|---|---|---|---|---|---|---|---|
| | | Composition | | | | | | | | | | | Properties of Liquid Medium | | | |
| | | | | | | Resin | | | | Liquid | | | | | Swelling | Swelling |
| | | Colorant | | | | Material | | Dispersant | | Medium | | Viscos- | Boil- | | Ratio (%) | Ratio (%) |
| | | | content | | content | | content | | content | | content | ity | ing | Vapor | of Cured | of Cured |
| | | | (pts. | | (pts. | | (pts. | | (pts. | | (pts. | (mP · | Point | Pressure | Epoxy | Urethane |
| | | | wt.) | | wt.) | | wt.) | | wt.) | | wt.) | S) | (° C.) | (mmHg) | Adhesive | Adhesive |
| Ex 9 | R | PR254 | 5.2 | PY150 | 2.0 | a | 2.0 | b | 4.8 | C | 86.0 | 10.3 | 242.0 | 0.02 | 27.30 | 58.75 |
| | G | PG36 | 7.1 | PY150 | 2.9 | a | 2.3 | b | 4.8 | C | 82.9 | 11.6 | 242.0 | 0.02 | 27.30 | 58.75 |
| | B | PB15:6 | 4.8 | — | — | a | 1.9 | b | 4.5 | C | 88.8 | 10.5 | 242.0 | 0.02 | 27.30 | 58.75 |
| Ex 10 | R | PR254 | 5.0 | PY150 | 1.9 | a | 2.2 | b | 4.8 | D | 86.1 | 8.8 | 246.8 | 0.04 | 31.6 | 67.1 |
| | G | PG36 | 7.0 | PY150 | 2.8 | a | 2.5 | b | 5.2 | D | 82.5 | 8.6 | 246.8 | 0.04 | 31.6 | 67.1 |
| | B | PB15:6 | 4.9 | — | — | a | 2.0 | b | 4.8 | D | 88.3 | 8.2 | 246.8 | 0.04 | 31.6 | 67.1 |
| Ex 11 | R | PR254 | 5.1 | PY150 | 1.9 | a | 2.2 | b | 5.1 | E | 85.7 | 8.0 | 232.0 | 0.04 | 32.27 | 112.83 |
| | G | PG36 | 7.0 | PY150 | 2.8 | a | 2.5 | b | 5.2 | E | 82.5 | 7.8 | 232.0 | 0.04 | 32.27 | 112.83 |
| | B | PB15:6 | 4.7 | — | — | a | 2.1 | b | 4.8 | E | 88.4 | 7.6 | 232.0 | 0.04 | 32.27 | 112.83 |
| Ex 12 | R | PR254 | 5.2 | PY150 | 2.1 | a | 2.2 | b | 4.8 | F | 85.7 | 8.8 | 187.0 | 0.04 | 25.27 | 136.86 |
| | G | PG36 | 7.4 | PY150 | 2.9 | a | 2.5 | b | 5.2 | F | 82.0 | 8.6 | 187.0 | 0.04 | 25.27 | 136.86 |
| | B | PB15:6 | 4.9 | — | — | a | 2.1 | b | 4.6 | F | 88.4 | 8.2 | 187.0 | 0.04 | 25.27 | 136.86 |
| Ex 13 | R | PR254 | 5.0 | PY150 | 1.9 | a | 2.1 | b | 4.7 | G | 86.3 | 7.5 | 243.0 | 0.03 | 32.40 | 149.57 |
| | G | PG36 | 7.0 | PY150 | 2.7 | a | 2.2 | b | 5.1 | G | 83.0 | 7.7 | 243.0 | 0.03 | 32.40 | 149.57 |
| | B | PB15:6 | 4.7 | — | — | a | 1.8 | b | 4.9 | G | 88.6 | 7.4 | 243.0 | 0.03 | 32.40 | 149.57 |

TABLE 3

| | | Color Filter Ink | | | | | | | | | | | | | | |
|---|---|---|---|---|---|---|---|---|---|---|---|---|---|---|---|---|
| | | Composition | | | | | | | | | | | Properties of Liquid Medium | | | |
| | | | | | | Resin | | | | Liquid | | | | | Swelling | Swelling |
| | | Colorant | | | | Material | | Dispersant | | Medium | | Viscos- | Boil- | | Ratio (%) | Ratio (%) |
| | | | content | | content | | content | | content | | content | ity | ing | Vapor | of Cured | of Cured |
| | | | (pts. | | (pts. | | (pts. | | (pts. | | (pts. | (mP · | Point | Pressure | Epoxy | Urethane |
| | | | wt.) | | wt.) | | wt.) | | wt.) | | wt.) | S) | (° C.) | (mmHg) | Adhesive | Adhesive |
| C. | R | PR254 | 5.1 | PY150 | 1.9 | a | 2.0 | b | 4.8 | G/H | 43.1/43.1 | 7.6 | 230.0 | 0.06 | 39.0 | 149.17 |
| Ex 1 | G | PG36 | 7.5 | PY150 | 2.8 | a | 2.2 | b | 4.9 | G/H | 41.3/41.3 | 7.7 | 230.0 | 0.06 | 39.0 | 149.17 |
| | B | PB15:6 | 4.8 | — | — | a | 1.9 | b | 4.9 | G/H | 44.2/44.2 | 7.4 | 230.0 | 0.06 | 39.0 | 149.17 |
| C. | R | PR254 | 5.2 | PY150 | 2.0 | a | 2.2 | b | 4.6 | A/I | 25.8/60.2 | 8.1 | 227.3 | 0.05 | 40.66 | 150.21 |
| Ex 2 | G | PG36 | 7.5 | PY150 | 2.9 | a | 2.1 | b | 5.0 | A/I | 24.8/57.7 | 8.3 | 227.3 | 0.05 | 40.66 | 150.21 |
| | B | PB15:6 | 4.8 | — | — | a | 1.8 | b | 4.5 | A/I | 26.7/62.2 | 7.9 | 227.3 | 0.05 | 40.66 | 150.21 |
| C. | R | PR254 | 5.3 | PY150 | 2.0 | a | 2.1 | b | 4.8 | A/J | 25.7/60.1 | 8.6 | 269.5 | 0.03 | 33.68 | 249.26 |
| Ex 3 | G | PG36 | 7.5 | PY150 | 2.9 | a | 2.2 | b | 5.2 | A/J | 24.7/57.5 | 8.8 | 269.5 | 0.03 | 33.68 | 249.26 |
| | B | PB15:6 | 4.8 | — | — | a | 1.8 | b | 4.5 | A/J | 26.8/62.5 | 8.4 | 269.5 | 0.03 | 33.68 | 249.26 |
| C. | R | PR254 | 5.3 | PY150 | 2.0 | a | 2.0 | b | 4.7 | A/K | 25.9/60.3 | 7.5 | 228.0 | 0.03 | 43.55 | 186.25 |
| Ex 4 | G | PG36 | 7.5 | PY150 | 2.9 | a | 2.1 | b | 4.9 | A/K | 24.8/57.9 | 7.6 | 228.0 | 0.03 | 43.55 | 186.25 |
| | B | PB15:6 | 4.8 | — | — | a | 1.8 | b | 4.6 | A/K | 26.6/62.2 | 7.3 | 228.0 | 0.03 | 43.55 | 186.25 |
| C. | R | PR254 | 5.0 | PY150 | 2.2 | a | 2.1 | b | 4.7 | H | 86.0 | 7.7 | 217.0 | 0.099 | 45.63 | 149.80 |
| Ex 5 | G | PG36 | 7.2 | PY150 | 2.8 | a | 2.1 | b | 4.9 | H | 83.0 | 7.9 | 217.0 | 0.099 | 45.63 | 149.80 |
| | B | PB15:6 | 4.8 | — | — | a | 1.9 | b | 5.1 | H | 88.2 | 7.6 | 217.0 | 0.099 | 45.63 | 149.80 |
| C. | R | PR254 | 5.3 | PY150 | 1.9 | a | 2.9 | b | 5.4 | I | 84.5 | 7.8 | 215.0 | 0.097 | 54.95 | 222.5 |
| Ex 6 | G | PG36 | 7.2 | PY150 | 2.0 | a | 2.8 | b | 5.0 | I | 83.0 | 8.0 | 215.0 | 0.097 | 54.95 | 222.5 |
| | B | PB15:6 | 4.4 | — | — | a | 1.8 | b | 4.9 | I | 88.9 | 7.7 | 215.0 | 0.097 | 54.95 | 222.5 |
| C. | R | PR254 | 5.1 | PY150 | 1.9 | a | 2.9 | b | 4.8 | J | 85.3 | 9.0 | 275.3 | 0.04 | 45.86 | 350.1 |
| Ex 7 | G | PG36 | 7.2 | PY150 | 2.0 | a | 1.9 | b | 5.1 | J | 83.8 | 9.2 | 275.3 | 0.04 | 45.86 | 350.1 |
| | B | PB15:6 | 4.5 | — | — | a | 2.4 | b | 5.8 | J | 87.3 | 8.8 | 275.3 | 0.04 | 45.86 | 350.1 |
| C. | R | PR254 | 5.0 | PY150 | 2.0 | a | 2.7 | b | 5.0 | K | 85.3 | 7.4 | 216.0 | 0.04 | 52.40 | 1152.73 |
| Ex 8 | G | PG36 | 7.0 | PY150 | 3.1 | a | 1.5 | b | 5.1 | K | 83.3 | 7.6 | 216.0 | 0.04 | 52.40 | 1152.73 |
| | B | PB15:6 | 5.0 | — | — | a | 1.9 | b | 5.0 | K | 88.1 | 7.2 | 216.0 | 0.04 | 52.40 | 1152.73 |

### 2. Production of Color Filter

The color filter ink (the ink set) prepared in each of above Examples and Comparative Examples was used to produce a color filter in the following manner:

First, there was prepared a soda glass substrate having a size (G5) of 1100 mm×1300 mm where a silica (SiO₂) film was formed on each surface to prevent the elution of sodium ions. Then, the substrate was subjected to washing treatment.

Next, a carbon black-containing radiation-sensitive composite, which is used for partition wall formation, was applied on the entire area of a surface of the washed substrate to form a coating film.

Next, the prebaking of the substrate was performed under conditions of a heating temperature of 110° C. and a heating time of 120 seconds.

Thereafter, through a photomask, radiation was applied to perform a post-exposure baking (PEB) treatment, and sequentially followed by a developing process using an alkali developer. Furthermore, post-baking was performed to form the partition walls. The PEB treatment was performed under conditions of the heating temperature of 110° C., the heating time of 120 seconds, and a radiation mean intensity of 150 mJ/cm². Additionally, for example, the developing process was performed by a vibration-dipping method. The development time was 60 seconds. The post-baking process was performed under conditions of a heating temperature of 150° C. and a heating time of 5 minutes. The formed partition walls each had a thickness of 2.1 μm.

Next, the liquid droplet discharging apparatus as shown in each of FIGS. 3 to 6B was used to discharge the color filter inks in the cells as regions surrounded by the partition walls. In this case, the color filter inks of the three colors were discharged in such a manner that the color filter inks of the individual colors did not mix together. Additionally, regarding the liquid droplet discharging head used, the nozzle plate was bonded with the epoxy adhesive (AE-40 manufactured by Ajinomoto-Fine-Techno Co. Ltd.), and the oscillation plate was bonded with the urethane adhesive (Hysol U-09FL manufactured by Henkel Corp.).

Thereafter, heating was performed on a hot plate at 100° C. for 10 minutes, and then, further heating was performed in an oven at 200° C. for 1 hour, whereby the colored portions of the three colors were formed. As a result, a color filter as shown in FIG. 1 was obtained.

Using the method as described above, the color filter ink (the ink set) of each of the Examples and the Comparative Examples described above was used to produce 1000 color filters, respectively.

### 3. Evaluation

Using each of the color filters produced as described above, evaluation was conducted as follows:

3-1. Irregularities of Color and Density, and Light Leakage

Among the color filters produced by using the color filter ink (the ink set) of each of the Examples and the Comparative Examples, each 1000th product was used to produce the liquid crystal display as shown in FIG. 7 under the same conditions.

Regarding the produced liquid crystal displays, visual checking was performed in a situation where a mono-color display of each of red, green, blue, and white was shown in a dark room. Thereby, the irregularities of color and density in each region was evaluated based on the following five criteria:

A: No irregularities of color and density, and no light leakage were observed.

B: Almost no irregularities of color and density, and almost no light leakage were observed.

C: The irregularities of color and density, and light leakage were slightly observed.

D: The irregularities of color and density, and light leakage were obviously observed.

E: The irregularities of color and density, and light leakage were remarkably observed.

3-2. Characteristic Variations among Color Filters

Among the color filters produced by using the color filter inks (the ink sets) of each of the Examples and the Comparative Examples, the 990th to 999th products were prepared. Then, a mono-color display of each of red, green, blue, and white was shown in a dark room to perform color measurements by using a microspectrophotometer (MCPD 3000 manufactured by Otsuka Electronics Co., Ltd.) Based on results of the measurements, regarding the 990th to 999th color filters produced in each of the Examples and Comparative Examples, maximum values of color difference (color difference ΔE in the Lab display system) were obtained and evaluated in accordance with the following five-point criteria:

A: Color difference ΔE is smaller than 2.

B: Color difference ΔE is 2 or larger and smaller than 3.

C: Color difference ΔE is 3 or larger and smaller than 4.

D: Color difference ΔE is 4 or larger and smaller than 5.

E: Color difference ΔE is 5 or larger.

In the above evaluation, observations and measurements of the color filters were performed under the same conditions.

Table 4 shows results of the evaluation.

TABLE 4

| | Irregularities of Color and Density, | | | | Characteristic Variations | | | |
|---|---|---|---|---|---|---|---|---|
| | and Light Leakage | | | | among Individual Products | | | |
| | Red | Green | Blue | White | Red | Green | Blue | White |
| | Display | Display | Display | Display | Display | Display | Display | Display |
| Ex 1 | A | A | A | A | A | A | A | A |
| Ex 2 | A | A | A | A | A | A | A | A |
| Ex 3 | A | A | A | A | A | A | A | A |
| Ex 4 | A | A | A | A | A | A | A | A |
| Ex 5 | A | A | A | A | A | A | A | A |
| Ex 6 | A | A | A | A | A | A | A | A |
| Ex 7 | A | A | A | A | A | A | A | A |
| Ex 8 | A | A | A | A | A | A | A | A |
| Ex 9 | A | A | A | A | A | A | A | A |
| Ex 10 | A | A | A | A | A | A | A | A |
| Ex 11 | A | A | A | B | A | A | A | B |
| Ex 12 | A | B | A | B | A | B | A | B |
| Ex 13 | A | B | A | B | A | B | A | B |
| C. Ex 1 | C | C | B | C | C | C | B | C |
| C. Ex 2 | C | C | B | D | C | C | B | D |
| C. Ex 3 | D | D | D | E | D | D | D | E |
| C. Ex 4 | C | D | C | E | C | D | C | E |
| C. Ex 5 | C | D | D | E | D | D | D | E |
| C. Ex 6 | E | E | E | E | E | E | E | E |
| C. Ex 7 | E | E | E | E | E | E | E | E |
| C. Ex 8 | E | E | E | E | E | E | E | E |

As obvious in Table 4, in the color filters according to the embodiment, the occurrences of color mixing, the irregularities of color and density, and light leakage were suppressed, and there were only a small characteristic variations among the color filters. In contrast, the above Comparative Examples did not show favorable results.

Additionally, commercially available liquid crystal television sets were disassembled and their liquid crystal displays were replaced by those produced in the above-described manner to evaluate them in the same manner as described above. The evaluation showed the same results as described above.

What is claimed is:

1. A color filter ink used for color filter production using an inkjet method, the color filter ink comprising:
a colorant; and
a liquid medium for at least one of dissolving and dispersing the colorant therein,
wherein the liquid medium has an adhesive swelling characteristic including:
causing a cured epoxy adhesive to have a swelling ratio of 35% or less after a product adhered with the cured epoxy adhesive is left undisturbed and sealed in the liquid medium for 6 days at a temperature of 70° C. and under atmospheric pressure; and
causing a cured urethane adhesive to have a swelling ratio of 160% or less after a product adhered with the cured urethane adhesive is left undisturbed and sealed in the liquid medium for 6 days at a temperature of 70° C. and under atmospheric pressure.

2. The color filter ink according to claim 1, wherein the epoxy adhesive includes an epoxy resin and an aliphatic polyamine.

3. The color filter ink according to claim 1, wherein the liquid medium has a boiling point in a range from 180 to 300° C. under atmospheric pressure.

4. The color filter ink according to claim 1, wherein the liquid medium has a vapor pressure of 0.1 mmHg or less at 25° C.

5. The color filter ink according to claim 1, wherein the liquid medium includes at least one compound selected from bis(2-butoxyethyl)ether, dipropylene glycol methyl ether acetate, methyl propylene triglycol, diethylene glycol monobutyl ether acetate, 1,3-butylene glycol diacetate, ethylene glycol diacetate, and 4-methyl-1,3-dioxolane-2-on.

6. A color filter produced by using the color filter ink according to claim 1.

7. An image display comprising the color filter according to claim 6.

8. The image display according to claim 7, wherein the image display comprises a liquid crystal display panel.

9. An electronic apparatus comprising the image display according to claim 7.

10. A liquid droplet discharging apparatus comprising:
a tank;
a color filter ink stored in the tank;
at least one liquid droplet discharging head in ink receiving communication with the tank and adapted to discharge the color filter ink to a desired location, the liquid droplet discharging head including:
a plurality of partition walls;
a nozzle plate bonded with a cured epoxy adhesive to at least one of the partition walls; and
an oscillation plate bonded with a cured urethane adhesive to at least one of the partition walls,
wherein the color filter ink includes:
a colorant; and
a liquid medium for at least one of dissolving and dispersing the colorant therein, the liquid medium causing:
the cured epoxy adhesive to have a swelling ratio of 35% or less after a product adhered with the cured epoxy adhesive is left undisturbed and sealed in the liquid medium for 6 days at a temperature of 70° C. and under atmospheric pressure; and
the cured urethane adhesive to have a swelling ratio of 160% or less after a product adhered with the cured urethane adhesive is left undisturbed and sealed in the liquid medium for 6 days at a temperature of 70° C. and under atmospheric pressure.

11. The color filter ink according to claim 10, wherein the epoxy adhesive includes an epoxy resin and an aliphatic polyamine.

12. The color filter ink according to claim 10, wherein the liquid medium has a boiling point in a range from 180 to 300° C. under atmospheric pressure.

13. The color filter ink according to claim 10, wherein the liquid medium has a vapor pressure of 0.1 mmHg or less at 25° C.

14. The color filter ink according to claim 10, wherein the liquid medium includes at least one compound selected from bis(2-butoxyethyl)ether, dipropylene glycol methyl ether acetate, methyl propylene triglycol, diethylene glycol monobutyl ether acetate, 1,3-butylene glycol diacetate, ethylene glycol diacetate, and 4-methyl-1,3-dioxolane-2-on.
